(19) United States
(12) Patent Application Publication
(10) Pub. No.: US 2001/0043624 A1
(43) Pub. Date: Nov. 22, 2001

(54) Switching system and routing method

(76) Inventors: Atsuko Saito, Yokohama (JP); Yuji Munakata, Yokohama (JP); Yutaka Obara, Yokohama (JP); Kazumi Muraki, Kawasaki (JP)

Correspondence Address: ROSENMAN & COLIN LLP, 575 MADISON AVENUE, NEW YORK, NY, 10022-2585, US

(21) Appl. No.: 09/785,090

(22) Filed: Feb. 16, 2001

(30) Foreign Application Priority Data
Feb. 25, 2000 (JP) 2000-049628

(51) Int. Cl. H04J 3/12

(52) U.S. Cl. 370/524; 370/395.1

(57) ABSTRACT

An switching system for routing a call setup request received from a subscriber device to a desired network among multiple networks having two or more different routing methods, based on information included in the call setup request.

### BACKGROUND OF THE INVENTION

1. Field of the Invention

The present invention relates to technology that routes a call from a subscriber to any of multiple routing networks to the desired network among multiple networks having at least one or more different routing systems.

2. Description of the Prior Art

It is to be noted that throughout the specification and all the drawings the same reference symbol indicates the same or an equivalent element.

FIG. 31 is a diagram for explaining an ATM network that routes calls by hop by hop, and FIG. 32 is a diagram for explaining an example of an ATM network that routes calls by source routing. Conventional ATM networks are of two types: networks that adopt the hop-by-hop routing system as shown in FIG. 31, and networks that adopt the source routing system as shown in FIG. 32. Normally, an ATM switching system deployed for a public ATM network is a network node interface (NNI) network connected by a B-ISUP broadband ISDN user's part) protocol; here this is called a hop-by-hop routing network.

In the hop-by-hop routing network, there may be two routes in the route from station A (the calling node) to station C (the called node), as shown for example in FIG. 31. At the station A, if a call setup request (call setup request message) to subscriber B addressed to station C is received from subscriber A (the subscriber device), the next hop is selected according to the preset priority of the next connectable hop. For example, assuming that at station A or station D is defined as a first-priority hop and station B is defined as a second-priority hop, then said call setup request will be transferred to station D via the physical circuit, and station D will transfer it to station C. If station D is not in operation because of some fault, etc., then the call setup request is transferred to second-priority station B, and station B transfers it to station C. Processing in which a received call setup request is routed to the next node (for example, aforesaid station D or station B) in this way is generally adopted in today's public ATM networks.

It is said that in a hop-by-hop routing network, the route that is generally selected is not necessarily the optimum route, although it also depends on the setting of the next hop.

FIG. 32 is a diagram for explaining an example of an ATM network that routes calls by source routing. Recently, a protocol known as PNNI (private network-network interface) has been proposed, and it has been adopted in particular for private networks within companies.

The PNNI, which is a protocol for doing source routing, is different from B-ISUP because it contemplates being used for the transfer of packets in a LAN (local area network). That is, a PNNI protocol has a topology protocol in addition to a signal protocol, and using this protocol, each node (for example, stations A, B, C, and D in FIG. 32) automatically recognizes the composition of nodes of a private network and manages the arrival possibility information, link state information, etc. as topology information. At the calling station (for example, station A in FIG. 32), the optimum route for the route to the called station (for example, station C in FIG. 32) is determined based on topology information passed back and forth on the network, and the call is connected from the calling station to the called station via the route prescribed by this determination.

Factors considered in selecting the optimum route include the state of the circuit, the state of each station, and quality information, because topology information is passed back and forth at all times between a local station and adjacent stations, is kept in a database of each station, and is synchronized. With the recent explosive growth in the volume of traffic of Internet protocol packets, it is thought highly likely that in the future PNNI or PNNI's successor will supplant B-ISUP and be adopted as standard for public ATM networks for such route selection functions and support functions for the high-speed propagation of topology and for the expansion of large networks.

There are two types of ATM networks—the hop-by-hop routing network as shown in FIG. 31, and the source routing network shown in FIG. 32—and the problem has been that a subscriber device cannot be connected to both of them. That is, it has only been possible for the subscriber device to be connected to one network or the other, but not both.

In recent years, along with the rapid growth in the volume of traffic of Internet protocol packets (IP traffic), high-speed, high-quality, and high-reliability communication services have come to be demanded for a wide variety of multimedia terminals. To meet this demand and make network management and maintenance easier, there has been a desire for some means of being able to connect to both hop-by-hop routing networks and PNNI source routing networks.

### SUMMARY OF THE INVENTION

It is an object of this invention to provide a means to route, based on an information element included in a call setup request received from a subscriber device, the call setup request to a network among multiple networks including at least one or more different routing methods.

It is another object of this invention to provide, in a switching system that accommodates a subscriber device and multiple networks, a means that connects a call from a subscriber so as to distribute the network load based on the state of each network.

It is another object of the present invention to provide, in a switching system that accommodates a subscriber device and multiple networks, a means that enables a subscriber to connect to a called station via a detour route if a connection cannot be made from the multiple networks to a network.

It is another object of the present invention to provide a switching system that accommodates a subscriber device and multiple networks, wherein a call setup request received from the subscriber device has multiple information on which routing is to be based, such that the call setup request be routed to a desired network according to the priority corresponding to each multiple information item.

The above objects of the present invention are attained by a switching system that is characterized in that, in a switching system that accommodates a subscriber device and multiple networks, based on an information element included in a call setup request received from the subscriber device, the call setup request is routed to a network among multiple networks. This system makes it possible for a subscriber device to connect from multiple networks to a desired network.

The multiple networks may be B-ISUP networks and PNNI networks.

The information element may be the value indicating the subscriber identifier.

The information may be the value indicating the channel identifier.

The information may be the value indicating the traffic class.

In an embodiment, the information element may the value indicating the network identifier indicating the desired routing destination.

In an embodiment, a switching system that accommodates a subscriber device and multiple networks has a call control means that routes to the selected network based on the state of use of each network when a call setup request is received from the subscriber device. The load on multiple networks can be adjusted by thus selecting networks based on their state of use.

In the switching system, when a setup request is received from the subscriber device, routing is done to the network of the larger remaining bandwidth of the networks.

In another embodiment, when a setup request is received from the subscriber device, routing is done to a network in which the call quantity per unit time of the networks is low.

According to still another embodiment, in a switching system that accommodates a subscriber device and multiple networks, a call setup request received from the subscriber device is routed to a desired network among the multiple networks, and when the call setup request is refused, the call setup request is routed to a network other than the desired network. By this means, connection can be made by a detour route if the network connected to from the subscriber device cannot be used due to a failure, etc.

In an embodiment, in a switching system that accommodates a subscriber device and multiple networks, a call setup request received from said subscriber device has multiple information that serves as the basis for routing and has data that indicates the priority corresponding to each the multiple information item, each the information item of the received call setup request is evaluated based on each data, and the call setup request is routed to a desired network according to the priority.

### BRIEF DESCRIPTION OF THE DRAWINGS

FIG. 1 is an operation summary diagram of a switching system for explaining multi-routing control;

FIG. 2 is a block diagram of a switching system and explaining the principles of operation of multi-routing control of the present invention;

FIG. 3 is a diagram for explaining an example of multi-routing control and operation data according to the invention;

FIG. 4 is a diagram for explaining information elements of a call setup message;

FIG. 5 is a diagram of the components of a switching system, the diagram explaining the processing flow (the common portion) of multi-routing control method;

FIG. 6 is a diagram for explaining the processing flow (the source routing portion) of multi-routing control method in a switching system of the present invention;

FIG. 7 is a diagram for explaining a processing flow (the hop-by-hop routing portion) of multi-routing control method in a switching system of the present invention;

FIG. 8 is a diagram for explaining an outline of operations by which a call setup request is routed to a desired routing method network based on information added to a set of subscriber data in a switching system of the present invention;

FIG. 9 is a diagram for explaining a processing flow (the common portion) by which a call setup request is routed to a desired routing method network based on information added to a set of subscriber data in a switching system of the present invention;

FIG. 10 is a diagram for explaining an outline of operations by which a call setup request is routed to desired routing method network based on VPI information added to the subscriber data in a switching system of the present invention;

FIG. 11 is a diagram for explaining a processing flow (the common portion) by which a call setup request is routed to a desired routing method network based on VPI information added to a set of subscriber data

FIG. 12 is a diagram for explaining an outline of operations by which a call setup request is routed to desired routing method network based on traffic class information added to a set of subscriber data in a switching system of the present invention;

FIG. 13 is a diagram for explaining a processing flow (the common portion) by which a call setup request is routed to a desired routing method network based on traffic class information added to the subscriber data in the switching system of the invention;

FIG. 14 is a diagram for explaining an outline of the operations by which a call setup request is routed to the desired routing method network based on remaining bandwidth information in the switching system of the present invention;

FIG. 15 is a diagram for explaining a processing flow (the common portion) by which a call setup request is routed to a desired routing method network based on remaining bandwidth information in the switching system of the present invention;

FIG. 16 is a diagram for explaining a processing flow (the source routing portion) by which a call setup request is routed to a desired routing method network based on remaining bandwidth information in a switching system of the invention;

FIG. 17 is a diagram for explaining a processing flow (the hop-by-hop routing portion) by which a call setup request is routed to a desired routing method network based on remaining bandwidth information in a switching system of the present invention;

FIG. 18 is a diagram for explaining an outline of operations by which a call setup request is routed to a desired routing method network based on information elements included in a call setup request in a switching system of the present invention;

FIG. 19 is a diagram for explaining a processing flow (the common portion) by which a call setup request is routed to a desired routing method network based on information elements included in the call setup request in a switching system of the present invention;

FIG. 20 is a diagram for explaining an outline of operations by which a call setup request is routed to a desired routing method network based on information elements (calling party number) included in the call setup request in a switching system of the present invention;

FIG. 21 is a diagram for explaining a processing flow (the common portion) by which a call setup request is routed to a desired routing method network based on information elements (calling party number) included in the call setup request in a switching system of the present invention;

FIG. 22 is a diagram for explaining an outline of operations by which routing is done to a desired routing method network according to the call quantity per unit time at the calling station in a switching system of the present invention;

FIG. 23 is a diagram for explaining a processing flow (the common portion) by which routing is done to a desired routing method network according to the call quantity per unit time at a calling station in a switching system of the present invention;

FIG. 24 is a diagram for explaining a processing flow (source routing) by which routing is done to a desired routing method network according to the call quantity per unit time at a calling station in a switching system of the present invention;

FIG. 25 is a diagram for explaining a processing flow (hop-by-hop routing) by which routing is done to a desired routing method network according to the call quantity per unit time at a calling station in a switching system of the present invention;

FIG. 26 is a diagram for explaining an outline of operations by which a call setup request from a subscriber is detour-controlled when congestion or a fault occurs;

FIG. 27 is a diagram for explaining a processing flow (part 1) by which a call setup request from a subscriber is detour-controlled when congestion or a fault occurs;

FIG. 28 is a diagram for explaining the processing flow (part 2) by which a call setup request from a subscriber is detour-controlled when congestion or a fault occurs;

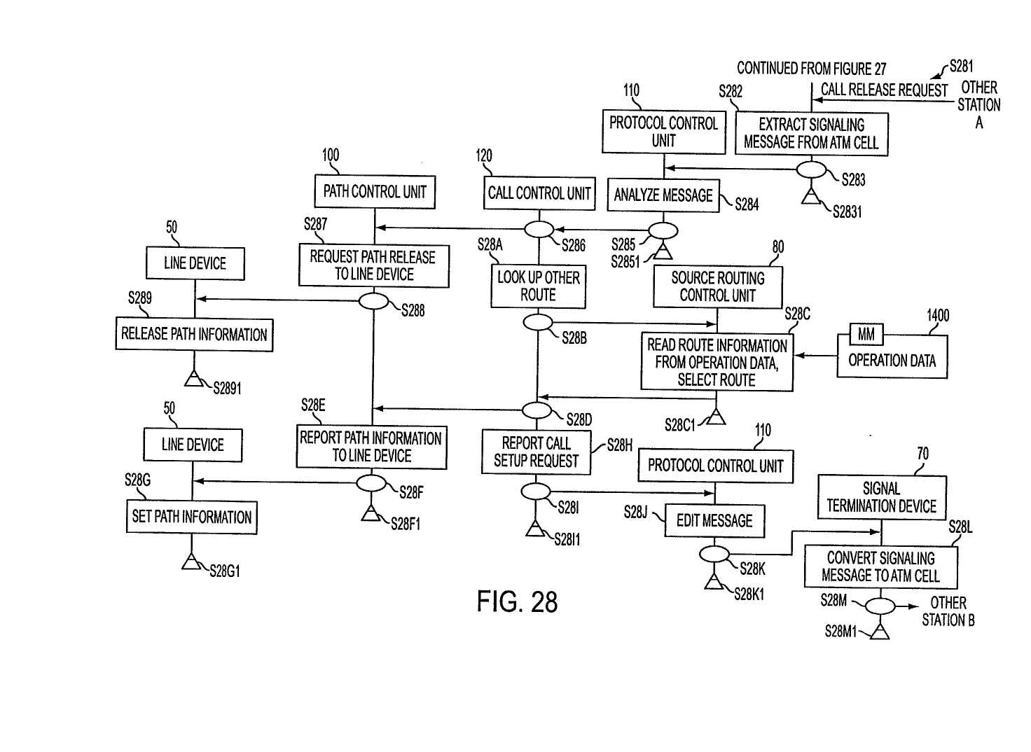

FIG. 29 is a diagram for explaining an outline of operations by which a call setup request is routed to a desired routing method network based on information elements added to the call setup request and the priority set in subscriber information in a switching system of the present invention;

FIG. 30 is a diagram for explaining a processing flow (the common portion) by which a call setup request is routed to a desired routing method network based on information elements added to the call setup request and the priority set in subscriber information in a switching system of the present invention;

FIG. 31 diagrammatically shows a conventional ATM network that routes calls by hop by hop; and

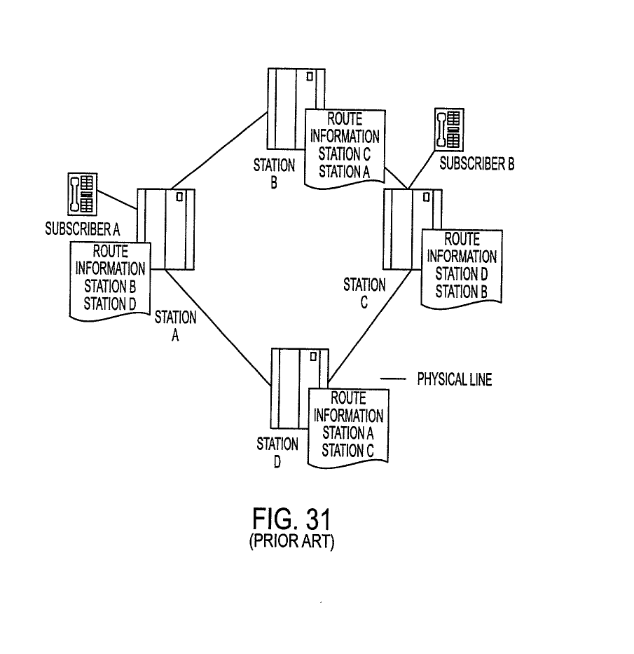

FIG. 32 diagrammatically shows a conventional ATM network that routes calls by source routing.

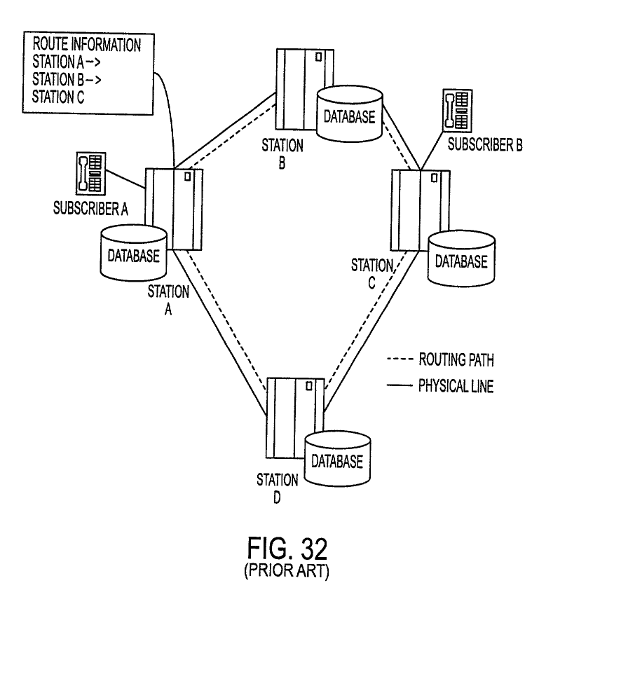

### DETAILED DESCRIPTION OF THE PREFERRED EMBODIMENTS

1. Overall Composition of the Present Invention

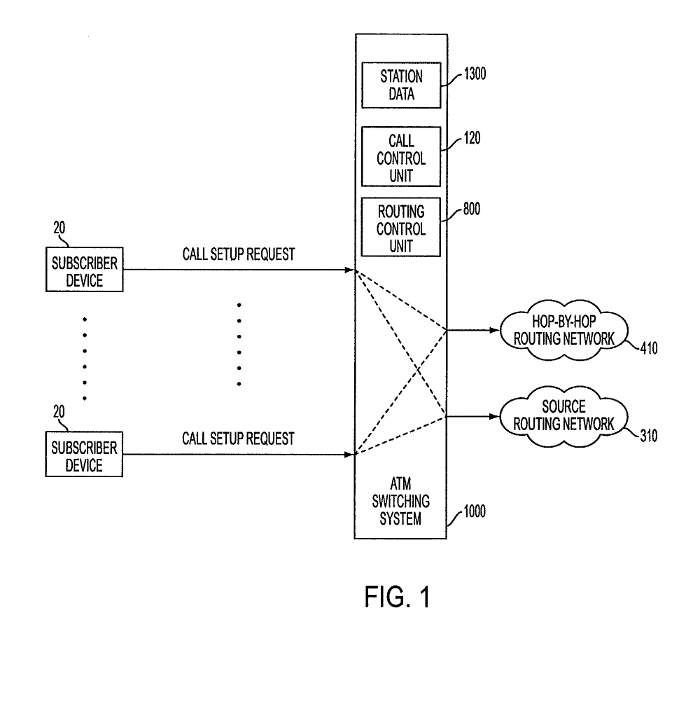

FIG. 1 is an operation summary diagram for explaining multi-routing control.

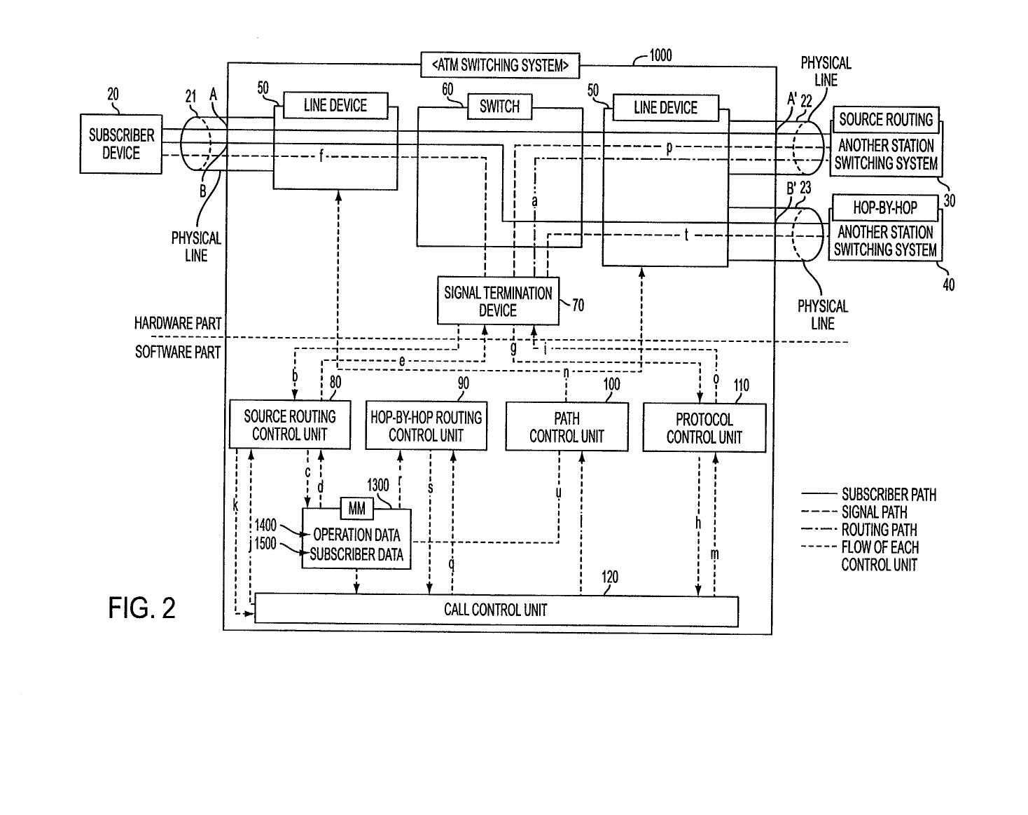

In FIG. 1 an ATM switching system 1000 is a system that has the function of routing-processing a call setup request input from a subscriber device 20 to a desired routing system network. That is, ATM switching system 1000 accommodates multiple subscriber devices 20, and is connected to a hop-by-hop routing network 410, and a source routing network 310. A call control unit 120 of the ATM switching system 1000 compares the information contained in the call setup request received from subscriber device 20 with station data 1300 and extracts the network identification information that corresponds to this information. The station data 1300 includes operation data 1400 and subscriber data 1500 (shown in FIG. 2).

A routing control unit 800 can do routing so that a call setup request arrives at a called terminal via a desired routing system network in accordance with the network identification information. As shown in FIG. 2 a routing control unit 800 includes a source routing control unit 80 and a hop-by-hop routing control unit 90. The storage format of operation data 1400 and subscriber data 1500 is described below.

FIG. 2 is a diagram of a switching system, which diagram explains the principles of operation of multi-routing control of this invention.

ATM switching system 1000 connects subscriber device 20, another source routing-type station switching system 30, and another hop-by-hop routing type switching system 40 by physical circuits 21, 22, 23, respectively. Normally, at least one or more subscriber devices 20, other switching systems 30, and other switching systems 40 are connected. As physical circuits 21, 22, 23, one may use, for example, optical fiber cables.

ATM switching system 1000 includes multiple line devices 50, and each line device 50 can accommodate at least one or more physical lines. Also, line device 50 can be installed as an external device attached to the outside of ATM switching system 1000.

Circuit device 50 is the device where physical lines 21, 22, 23 terminate.

For example, when lines device 50 receives an ATM cell from subscriber device 20, it adds tag information corresponding to the VPI (virtual path identifier) and VCI (virtual channel identifier) of the header of the cell and transfers it to a switch 60, and when it sends an ATM cell from switch 60, it sets in the cell header the VPI and VCI information that corresponds to the tag information added to the ATM cell. Also, the tag information that corresponds to the VPI and VCI information is set or released according to the set or release request of the path information received from path control unit 100.

Switch 60 is a switch that routes each ATM cell input from line device 50 to a desired path according to the instructions of a signal termination device 70.

Signal termination device 70 terminates the routing paths (f, p, t in the diagram) with subscriber device 20, another switching system 30, and another switching system 40. For example, a call setup request (setup message) of UNI (user network interface) format sent from subscriber device 20 is terminated by signal termination device 70, and by a protocol control unit 110 and a call control unit 120 this call setup request is converted to a message of NNI (network-to-network interface) format or a message of PNNI format, and it is transferred to another switching system 40 via signal termination device 70 and line device 50. Also, the transmission and reception of network information concerning PNNI is done via signal termination device 70.

The signal termination device 70 receives via line device 50 a routing message received from the source routing network (a in FIG. 2) and sends this message to source routing control unit 80.

The source routing control unit 80, linked with call control unit 120, performs reception processing of the network information from the PNNI network via another station switching system 30 and call processing of the network information, and performs routing processing of the call setup request.

Included in the network information are a Hello packet that conveys information on the logical node to which the local node belongs, etc., group information concerning reachable ATM addresses, a PNNI topology state packet that conveys the state of the traffic including usable bandwidth and quality, a database reservation packet that is used for database synchronization, and a PTSE (PNNI topology state element) request packet.

The hop-by-hop routing control unit 90 is linked with call control unit 120 and performs routing processing of the call setup request.

The path control means 100, linked with call control unit 120, performs setting or releases of the path information on line device 50 (n in FIG. 2).

The protocol control unit 110 analyzes the message included in the call setup request received from signal termination device 70 and conveys to call control means 120 such call setup information as path information, quality information, and the address information (h in FIG. 2).

Call control unit 120 receives the call setup information from protocol control unit 110 and extracts from the call setup information the path information, quality information, address information, etc. When doing so, the routing is determined by referring to information concerning routing from operation data 1400 or referring to information concerning routing provided from protocol control unit 110 (i in FIG. 2), and a route lookup request (j, q in FIG. 2) is made to source routing control unit 80 or hop-by-hop routing control unit 90.

Also, based on routing information from source routing control unit 80 or hop-by-hop routing control unit 90 (k, s in FIG. 2), call control means 120 makes a path setup request to path control unit 100 (1 in FIG. 2) and makes a signaling message sending request to protocol control unit 110 (m in FIG. 2).

2. An Overall Explanation of an Operation of ATM Switching System 1000.

2.1. Overall Operation of Source Routing

(1) Message Reception from Another Station Switching System

If the ATM switching system 1000 receives network information such as a PNNI topology protocol packet (information reading request, etc.) from another station switching system 30 (on the right side in FIG. 2) that adopts source routing, it operates as follows.

Signal termination device 70 receives network information from the switching system 30 on the source routing network (a in FIG. 2).

Signal termination device 70 notifies source routing control unit 80 of the received network information (b in FIG. 2).

Source routing control unit 80 analyzes the network information, and operates so as to synchronize the source routing information of operation data 1400 with the corresponding PNNI node, for example, another station switching system 30 (c in FIG. 2).

The details of the storage format of operation data 1400 are described below in paragraph 2.3.

(2) Message Transmission to Another Station Switching System

When ATM switching system 1000 sends network information (PNNI topology information) to another station switching system 30 (FIG. 2) that adopts PNNI source routing, it operates as follows.

Signal termination device 70 receives a network information reading request from the switching system 30 (a in FIG. 2) and informs source routing control unit 80 (b in FIG. 2).

Source routing control unit 80 reads the network information from operation data 1400 (database) (d in FIG. 2) and sends the network information to signal termination device 70 (e in FIG. 2).

Signal termination device 70 sends the network information to another station switching system 30 (a in FIG. 2).

(3) Reception of Call Setup Request Message, etc. from Subscriber Device

If ATM switching system 1000 receives a call setup request message, etc. from a subscriber device 20, it operates as follows.

Signal termination device 70 receives a call setup request message or other signaling message from the subscriber device 20, (f in FIG. 2), and notifies protocol control unit 110 (g in FIG. 2).

Protocol control unit 110 analyzes said message and notifies call control unit 120 of the call information, including path information, quality information, and address information. Protocol control unit 110 notifies call control unit 120 of said call information (h in FIG. 2).

Call control unit 120 analyzed the path information, quality information, and address information it has been given from protocol control unit 110. In doing so, it determines the desired routing network by referring to the use network identifier (i in FIG. 2) or based on the use network identifier it has been notified of from protocol control unit 110 (h in FIG. 2), and makes a route lookup request to source routing control unit 80 (j in FIG. 2).

Source routing control unit 80 refers to the source routing information in operation data 1400 (d in FIG. 2), selects the route, and gives the route information to call control unit 120 (k in FIG. 2).

Call control unit 120 makes a path setup request to path control means 100 (l in FIG. 2).

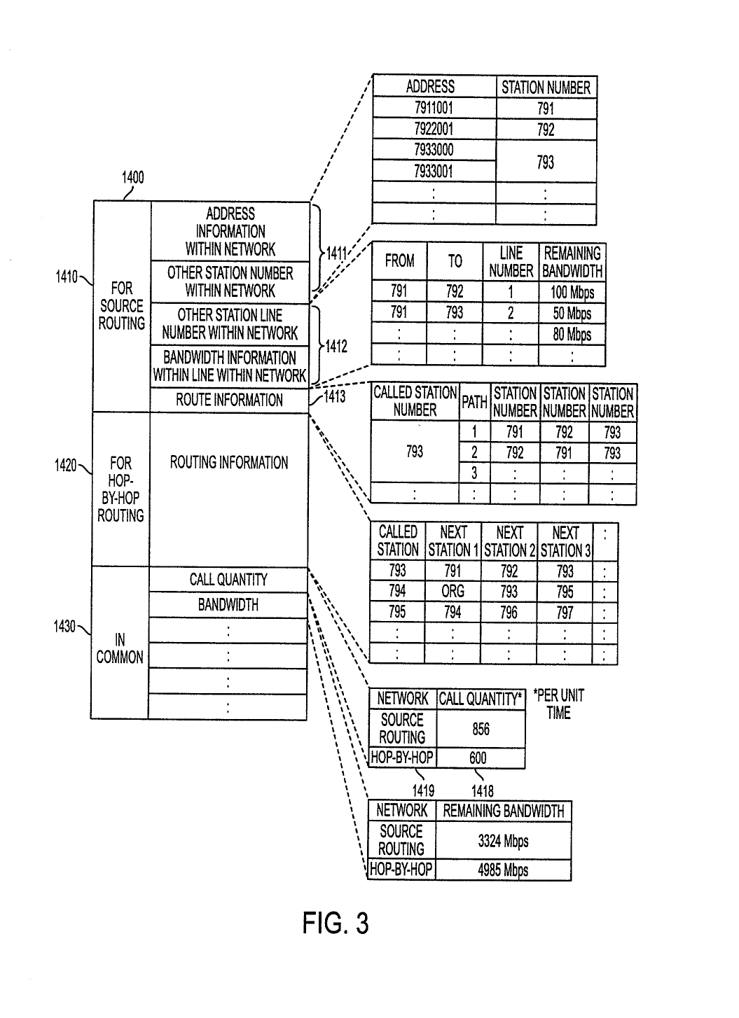

Path control unit 100 makes a path information setup request to line device 50 (n in FIG. 2) and sets it in common 1410 of call quantity per unit time and remaining bandwidth operation data 1400 (FIG. 3). Also, it sets the remaining bandwidth in operation data 1400 (u in FIG. 2).

Call control means 120 gives protocol control unit 110 the call information, including path information, quality information, address information, and routing information (m in FIG. 2).

Protocol control unit 110 edits said message, specifies the transmission destination of the message from call control unit 120, and makes this message sending request to signal termination device 70 (o in FIG. 2).

Signal termination device 70 sends the message to the specified transmission destination (for example, another station switching system 30) (p in FIG. 2).

(4) Reception of Call Setup Request Message from Other STATION Switching System

If ATM switching system 1000 receives a call setup request message, etc. from another station switching system, it operates as follows.

Signal termination device 70 receives a call setup request message or other signaling message (p in FIG. 2) and gives this signaling message to protocol control unit 110 (g in FIG. 2).

Protocol control unit 110 analyzes the received message and informs the call control unit 120 of the call information, including the path information, quality information, address information, and routing information (h in FIG. 2).

Call control unit 120 analyzes the received path information, quality information, and address information. Also, based on the routing information it has been given from protocol control unit 110, call control unit 120 makes a route check request to source routing control unit 80 (j in FIG. 2).

Source routing control unit 80 refers to the routing information (source routing information) of operation data 1400 (d in FIG. 2), does a route check, and gives the route information to call control unit 120 (k in FIG. 2).

Call control unit 120 makes a path setup request to path control unit 100 (l in FIG. 2).

Path control unit 100 makes a path information setup request to line device 50 (n in FIG. 2) and sets it in common 1410 of call quantity per unit time and remaining bandwidth operation data 1400 (FIG. 3). Also, it sets the remaining bandwidth in operation data 1400 (u in FIG. 2).

Call control unit 120 gives protocol control unit 110 the call information, including path information, quality information, address information, and routing information (m in FIG. 2).

Protocol control unit 110 edits said message, specifies the transmission destination of the message from call control unit 120, and transmits a message sending request to signal termination device 70 (o in FIG. 2).

Signal termination device 70 sends the message to the specified transmission destination (f in FIG. 2).

2.2 Overall Operation of Hop-by-hop Routing

(1) Upon Receipt of Call Setup Request Message from Subscriber Device

If ATM switching system 1000 receives a call setup request message, etc. from a subscriber device, it operates as follows.

Signal termination device 70 receives a call setup request message or other signaling message (f in FIG. 2) and notifies protocol control unit 110 (g in FIG. 2).

Protocol control unit 110 converts the UNI message received from subscriber device 20 into an NNI message and notifies the call control unit of the call setup information, including path information, quality information, and address information (h in FIG. 2).

In a system in which the routing is determined by the information elements in that message, the call control unit 120 is also informed of the routing information to be used (h in FIG. 2).

Call control unit 120 analyzes the path information, quality information, and address information. In doing so, it refers to the routing identifier (i in FIG. 2) or determines the routing based on use routing information it has been given from protocol control unit 110 (h in FIG. 2), and makes a route lookup request to hop-by-hop routing control unit 90 (q in FIG. 2).

Hop-by-hop routing control unit 90 refers to the routing information (hop-by-hop routing information) in the memory (r in FIG. 2), makes a route selection, and notifies call control of the adjacent station information (s in FIG. 2).

Call control unit 120 makes a path setup request to path control unit 100 (l in FIG. 2).

Path control unit 100 makes a path information setup request to line device 50 (n in FIG. 2) and sets the call quantity per unit time and remaining bandwidth in common 1410 of operation data 1400 (FIG. 3, u in FIG. 2).

Path control unit 100 gives protocol control unit 110 the call information, including path information, quality information, address information, and routing information (m in FIG. 2).

Protocol control unit 110 edits the message, specifies the transmission destination of the message from call control and transmits a message sending request to signal termination device 70 (o in FIG. 2).

Signal termination device 70 sends the message to the specified transmission destination (t in FIG. 2).

(2) Upon Receipt of Call Setup Request Message from Other Switching System

If ATM switching system 1000 receives a call setup request message, etc. from an other switching system, it operates as follows:

Signal termination device 70 receives a call setup request message or other signaling message (t in FIG. 2) and notifies protocol control unit 110 (g in FIG. 2).

Protocol control unit 110 converts the received UNI message into an NNI message and notifies call control unit 120 of the call setup information, including path information, quality information, and address information (h in FIG. 2).

Call control unit 120 analyzes the path information, quality information, and address information. Then it makes a route lookup request to hop-by-hop routing control unit 90 (q in FIG. 2).

Hop-by-hop routing control unit 90 refers to the routing information (hop-by-hop routing information) in the memory (r in FIG. 2), makes a route selection, and informs call control unit 120 of the selected route information (s in FIG. 2).

Call control unit 120 makes a path setup request to path control unit 100 (1 in FIG. 2).

Path control unit 100 makes a path information setup request to circuit device 50 (n in FIG. 2) and sets it in common 1410 of call quantity per unit time and remaining bandwidth operation data 1400 (FIG. 3). Also, it sets the remaining bandwidth in operation data 1400 (u in FIG. 2).

Call control unit 120 gives protocol control unit 110 the call information, including path information, quality information, address information, and routing information (m in FIG. 2).

Protocol control unit 110 edits the message, specifies the transmission destination of the message from call control unit 120, and transmits a message sending request to signal termination device 70 (o in FIG. 2).

Signal termination device 70 sends the message to the specified transmission destination (f in FIG. 2).

2.3 Storage Format of Data Relating to Multi-routing Control

FIG. 3 is a diagram that explains multi-routing control and an example of operation data. The composition of operation data 1400 is explained in line with the diagram of FIG. 3.

(1) Source Routing Information

Routing information 1410 is for source routing. Address information 1411 is within the network and is other station number information within the network; subscriber address and their station numbers are stored in it. Other station line numbers 1412 is within the network and remaining bandwidth information within lines within the network; station numbers of the From node (station) and To node (station) for specifying the path of a call setup request are stored in it. Also, the circuit number and the remaining bandwidth of the circuit (Mbps) are stored in it in correspondence with the From node (station) and To node (station).

Route information 1413 includes the path identification number to the called station being stored in it in association with the called station number. Also stored are the station numbers via which the received call setup request is to be transferred, in association with the path identification number.

(2) Hop-by-hop Routing Information

Routing information 1420 is for hop-by-hop routing. Stored in this routing information are the next hop (next station 1) of first priority for transferring the received call setup request to the called station, the next hop (next station 2) of second priority, the next hop (next station 3) of third priority, to the next hop (next station n) of n-th priority.

(3) Common Information

Common information 1430 is used in common for source routing processing and hop-by-hop routing processing; the remaining bandwidth and call quantity per unit time are stored for each routing method.

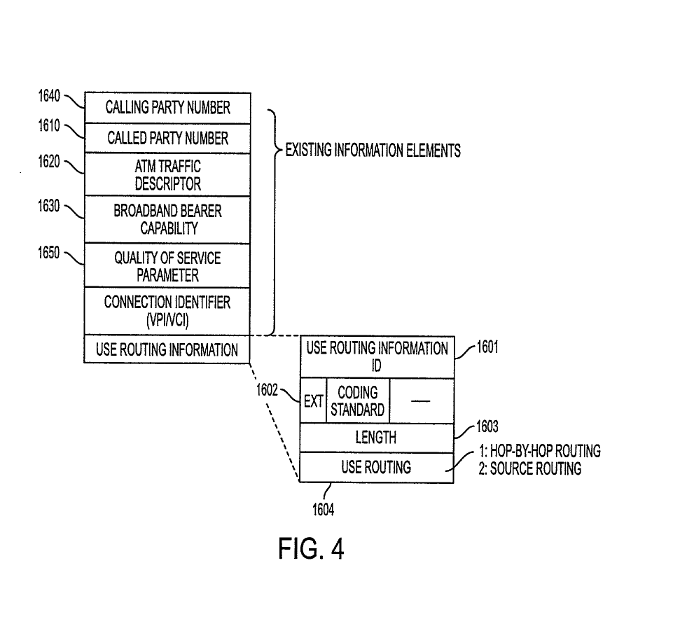

FIG. 4 is a diagram showing the information elements of a call setup message. calling party number, called party number, ATM traffic descriptor, broadband bearer capability, quality of service parameter, and connection identifier are set in the information elements included in the call setup request from subscriber device 20. The use routing information is included in the information elements.

In the use routing information, it consists of use routing information ID 1601 as an identifier for identifying the use routing information, EXT 1602 as the extension field, coding standard 1603 as the coding standard, use routing 1604, in which use routing information is stored, and length 1603 as length information. As existing information fields, there are ATM traffic descriptor 1620, which specifies information concerning the bandwidth, broadband bearer capability 1630, which specifies the traffic type (fixed speed, variable speed, etc.), and quality of service parameter 1650, which specifies the traffic class (quality class information).

3. Embodiments

3.1 First Embodiment

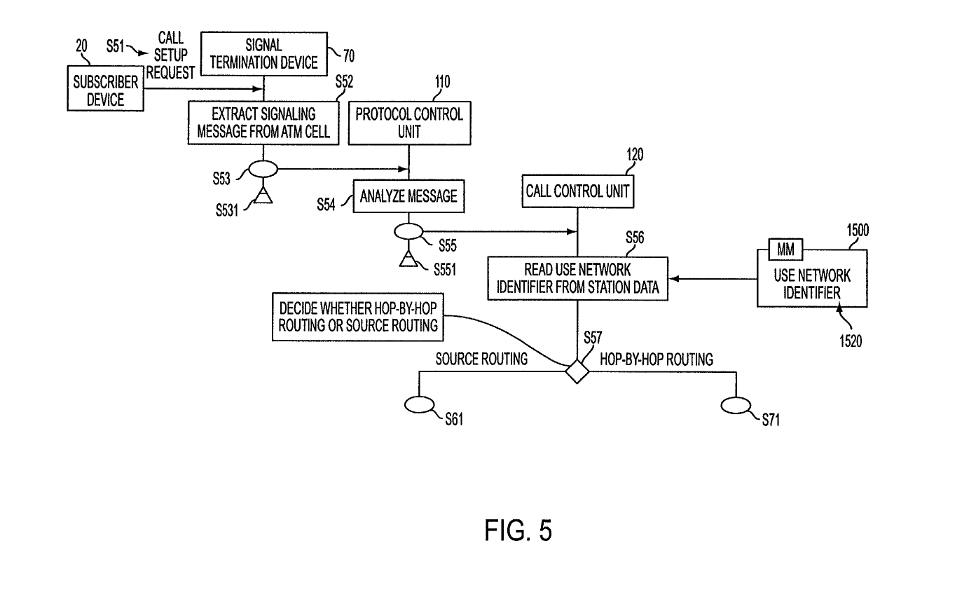

FIG. 5 explains the processing flow (the common portion) in the multi-routing control method; it is a diagram that explains the processing flow of the switching system of FIG. 1.

In FIG. 5, signal termination device 70 receives a call setup request from subscriber device 20, extracts the setup message, which is a signaling message included in this call setup request, activates protocol control unit 110, passes this setup message to it, and terminates the processing (steps S51 through S531).

The circle symbol in the diagram denotes activation of other processing (for example, step S53 in FIG. 5 denotes activation of protocol control unit 110), and the triangle symbol denotes termination of the processing (for example, step 531 in FIG. 5 is termination of the processing in signal termination device 70). This notation is the same in all the drawings.

Protocol control unit 110 analyzes said setup message received when activated from signal termination device 70, activates call control unit 120, passes the call setup information including the path information, subscriber information, quality information, and address, and terminates the processing (steps S54 through S551).

Call control unit 120 receives said call setup information, looks up subscriber data 1500 using the subscriber identification information that is included in said call setup information as the key, and reads use network identifier 1520, which corresponds to said subscription identification information. Included in read use network identifier 1520 is information indicating either a source routing network or a hop-by-hop routing network.

With regard to the type of the routing network, it does not matter if it is two or more networks (even if it is the same protocol, cases in which the version numbers are different may be included, and if separation is operationally necessary, it may be completely the same protocol and the same version number) (step S56).

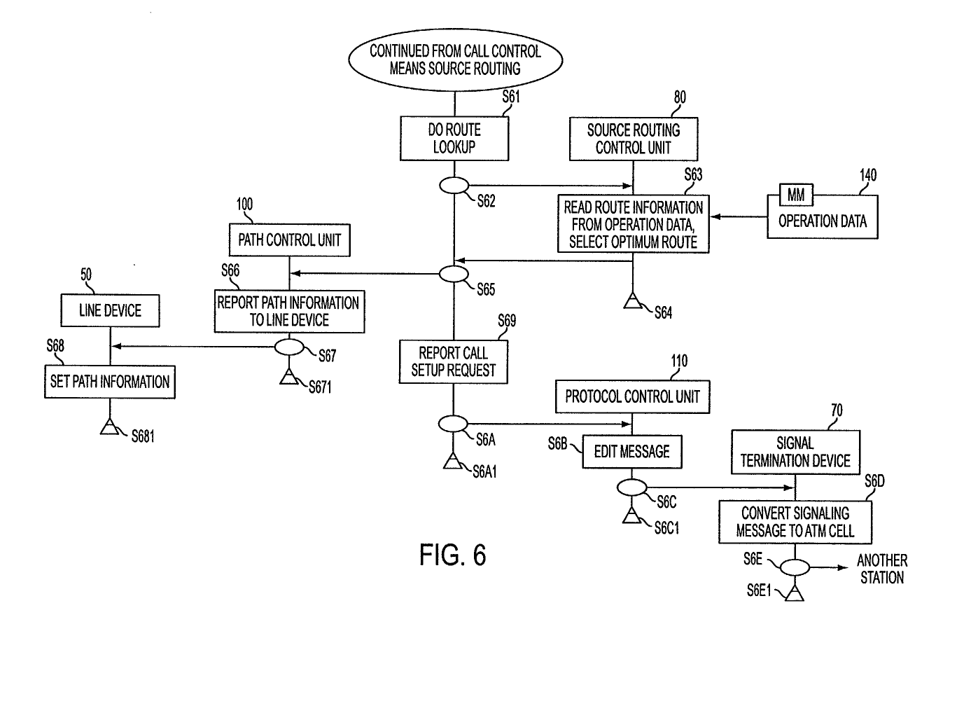

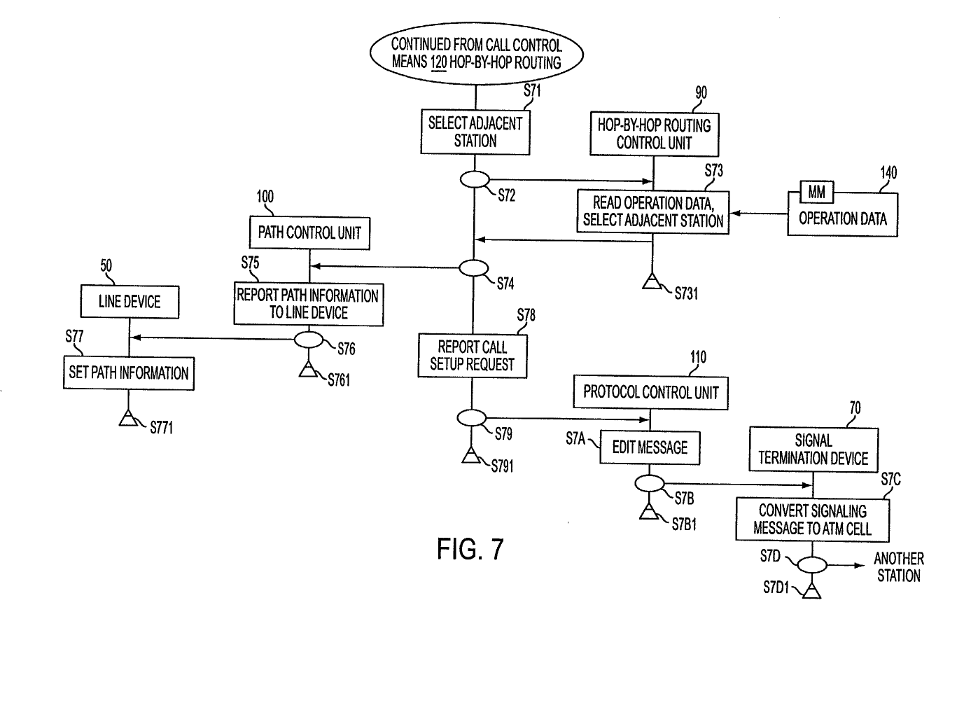

In step S57, if read use network identifier 1520 indicates a source routing network, one proceeds to step S61 (FIG. 6), and if it indicates a hop-by-hop routing network, one proceeds to step S71 (FIG. 7).

FIG. 6 shows the source routing processing flow in said multi-routing control method.

Step S61 is executed when use network identifier 1520 indicates a source routing network. In this step, call control unit 120 activates source routing control unit 80, asks it for a route (path) lookup request for causing said call setup request to arrive at the other-side subscriber device, and waits for notification of completion of this request processing (step S63) (steps S61 through S62).

In step S63, source routing control unit 80 selects the appropriate route information 1413 from operation data 1400, which includes 1410 for source routing route (FIG. 3), gives notice of completion of this processing to call control unit 120, which is the call origin, and passes on the selected route information (steps S63 through S64).

In step S65, call control unit 120 activates path control means 100 and passes on said route information. Path control unit 100 activates circuit device 50, and based on the route information informs circuit device 50 of the path information, and terminates this processing (steps S65 through S671).

In step S68, line device 50 sets the path based on the path information it has been passed, and terminates this processing (steps S68 through S681).

In aforesaid step S65, call control unit 120 activates aforesaid path control means 100, informs protocol control unit 110 of said call setup request, and terminates this processing (steps S65 through S6A1).

In step S6B, protocol control unit 110 edits the signaling message included in the call setup request, activates signal termination device 70, informs signal termination device 70 of the signaling message, and terminates this processing (steps S6B through S6C1).

In step S6D, the received signaling message is converted to an ATM cell and is sent via switch 60 to an other station, for example, another station switching system 30 connected to source routing network 310. Then it terminates this processing (steps S6D through S6E1).

FIG. 7 shows the processing flow of the multi-routing control method (the hop-by-hop routing portion).

In the diagram, in step S71, in order to select that hop that will handle the next hop-by-hop routing, call control unit 120 activates hop-by-hop routing control unit 90 and waits for the processing results from activated hop-by-hop routing control unit 90 (steps S71 through S72).

In step S73, hop-by-hop routing control unit 90 selects the next hop (adjacent station) by referring to hop-by-hop routing information 1420 of operation data 1400 in station data 1300 (FIG. 3). Then it passes the selection results (adjacent station information) to the activation source (call control means 120) and returns (steps S73 through S731).

In step S74, call control unit 120 activates path control means 100 and passes on said adjacent station information. Path control unit 100 activates line device 50, informs line device 50 of the path information based on said adjacent station information, and terminates this processing (steps S74 through S761).

In step S77, line device 50 sets the path based on the path information it has been passed. Then it terminates this processing (steps S77 through S771).

In aforesaid step S74, one activates aforesaid path control unit 100 and informs protocol control unit 110 of said call setup request. Then it terminates this processing (steps S74 through S791).

In step S7A, protocol control unit 110 edits the signaling message included in the call setup request message, activates signal termination device 70, and informs signal termination device 70 of the message. Then it terminates this processing (steps S7A through S7B1).

In step S7C, the received signaling message is converted to an ATM cell and is sent via switch 60 to an other station, for example, another switching system 40 connected to hop-by-hop routing network 410 (steps S7C through S7D 1).

3.2 Second Embodiment

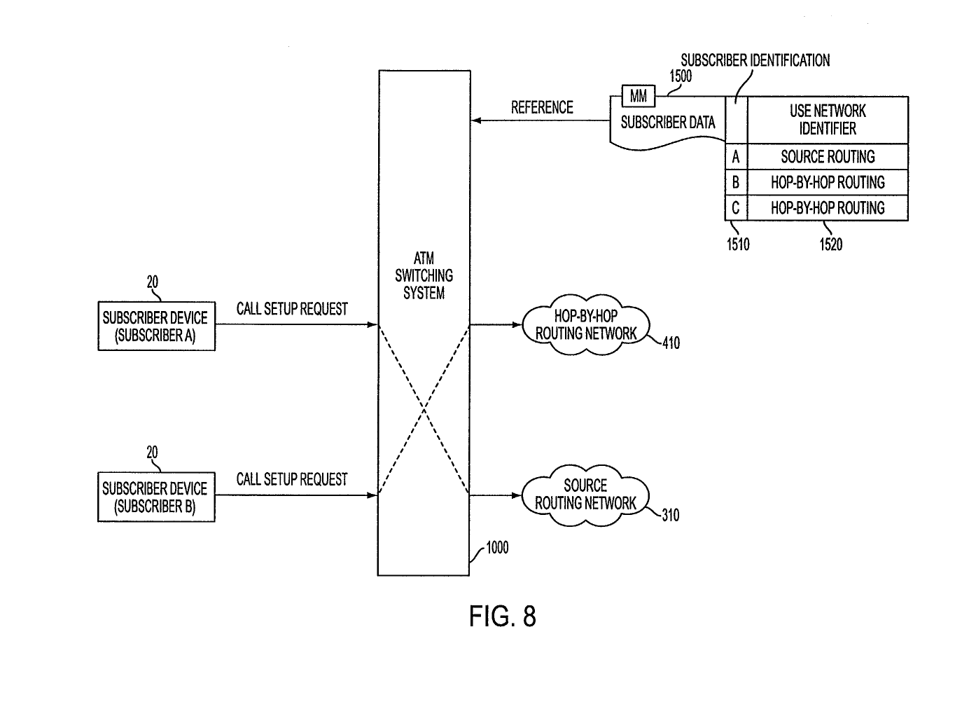

FIG. 8 explains an outline of operations by which a call setup request is routed to the desired routing method network based on information added to the subscriber data. What is different between FIG. 8 and FIG. 1 is that station data 1300 in FIG. 1 is made to correspond to the subscriber identifier and use network identifier in FIG. 8 and is specifically provided as subscriber data 1500.

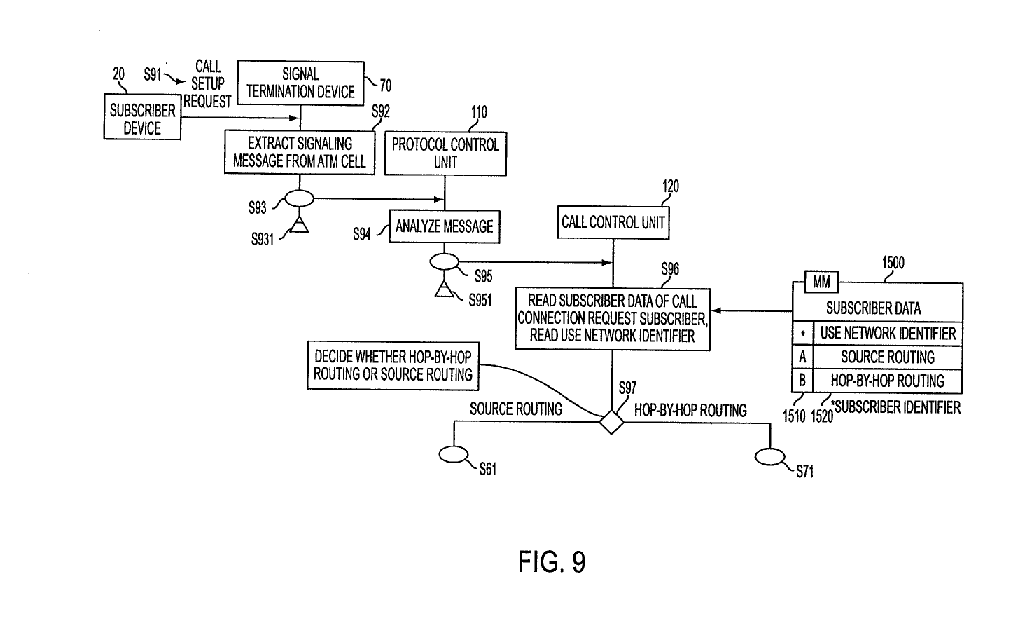

FIG. 9 explains the processing flow (the common portion) by which a call setup request is routed to the desired routing method network based on information added to the subscriber data. In the following an explanation is given as follows in line with FIG. 9.

In step S91, signal termination device 70 receives a call setup request from subscriber device 20, extracts the setup message, which is the signaling message included in this call setup request message, activates protocol control unit 110, passes it this setup message, and terminates this processing (steps S91 through S931).

In step S94, protocol control means 110 analyzes said setup message passed to it when it was activated from signal termination device 70, activates call control unit 120, passes it the call setup information, including path information, subscriber information, quality information, and address, and terminates this processing (steps S94 through S951).

In step S96, call control means 120 is passed the call setup information, and reads use network identifier 1520, by which a correspondence is made between the subscriber information included in said call setup information (for example, “A” on the right side of FIG. 9) and subscriber identifier 1510, which is set in subscriber data 1500.

Included in read use network identifier 1520 is information indicating either a source routing network or a hop-by-hop routing network. For example, according to subscriber data 1500 in FIG. 9, “source routing” is read as the use network identifier in which the subscriber identifier corresponds to “A”.

With regard to the type of the routing network, it does not matter if it is two or more networks (even if it is the same protocol, cases in which the version numbers are different may be included, and if separation is operationally necessary, it may be completely the same protocol and the same version number) (step S96).

In step S97, if read use network identifier 1520 indicates a source routing network, one proceeds to step S61 (FIG. 6), and if it indicates a hop-by-hop routing network, one proceeds to step S71 (FIG. 7).

3.3 Third Embodiment

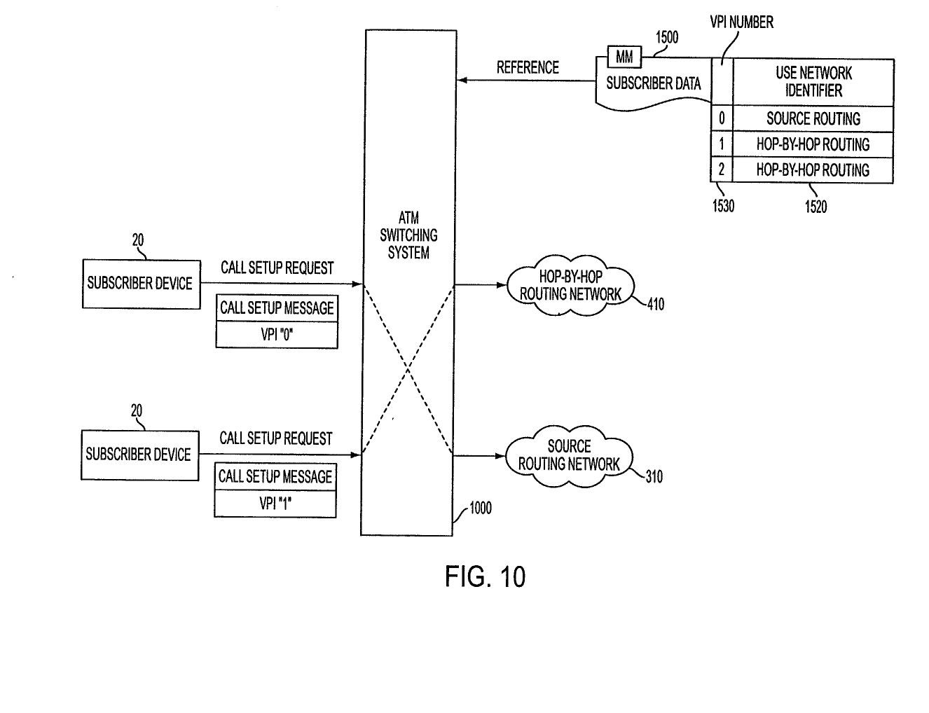

FIG. 10 shows an outline of operations by which a call setup request is routed to the desired routing method network based on the VPI information added to the subscriber data. What is different between FIG. 10 and FIG. 1 is that station data 1300 in FIG. 1 is made to correspond to VPI number 1530 included in the call setup request message from subscriber device 20 (VPI No.) and use network identifier 1520 in FIG. 10 and is provided as subscriber data 1500.

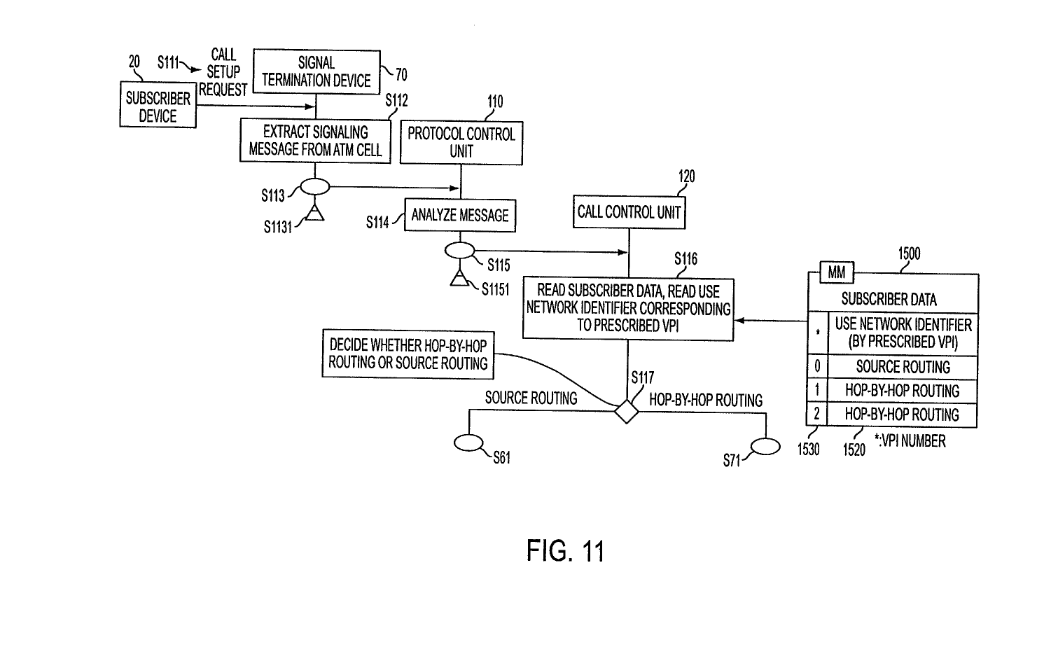

FIG. 11 shows the processing flow (the common portion) by which a call setup request is routed to the desired routing method network based on VPI information added to the subscriber data. In the following an explanation is given as follows in line with FIG. 11.

Signal termination device 70 receives a call setup request from subscriber device 20, extracts the setup message, which is the signaling message included in this call setup request message, activates protocol control unit 110, passes it this setup message, and terminates this processing (steps S111 through S1131).

Protocol control unit 110 analyzes said setup message passed to it when it was activated from signal termination device 70, activates call control unit 120, passes it the analyzed call setup information, including path information, subscriber information, quality information, and address, and terminates this processing (steps S114 through S1151).

Call control unit 120 is passed said call setup information, and reads use network identifier 1520, which corresponds to VPI number 1530 set in subscriber data 1500 included in said call setup information. Included in read use network identifier 1520 is information indicating either a source routing network or a hop-by-hop routing network. For example, according to subscriber data 1500 in FIG. 11, “hop-by-hop routing” is read as use network identifier 1520 in which the VPI number corresponds to “2”. With regard to the type of the routing network, it does not matter if it is two or more networks (even if it is the same protocol, cases in which the version numbers are different may be included, and if separation is operationally necessary, it may be completely the same protocol and the same version number) (step S116).

In step S117, if the value of use network identifier 1520 read by call control unit 120 indicates a source routing network, one proceeds to step S61 (FIG. 6), and if it indicates a hop-by-hop routing network, one proceeds to step S71 (FIG. 7).

3.4 Fourth Embodiment

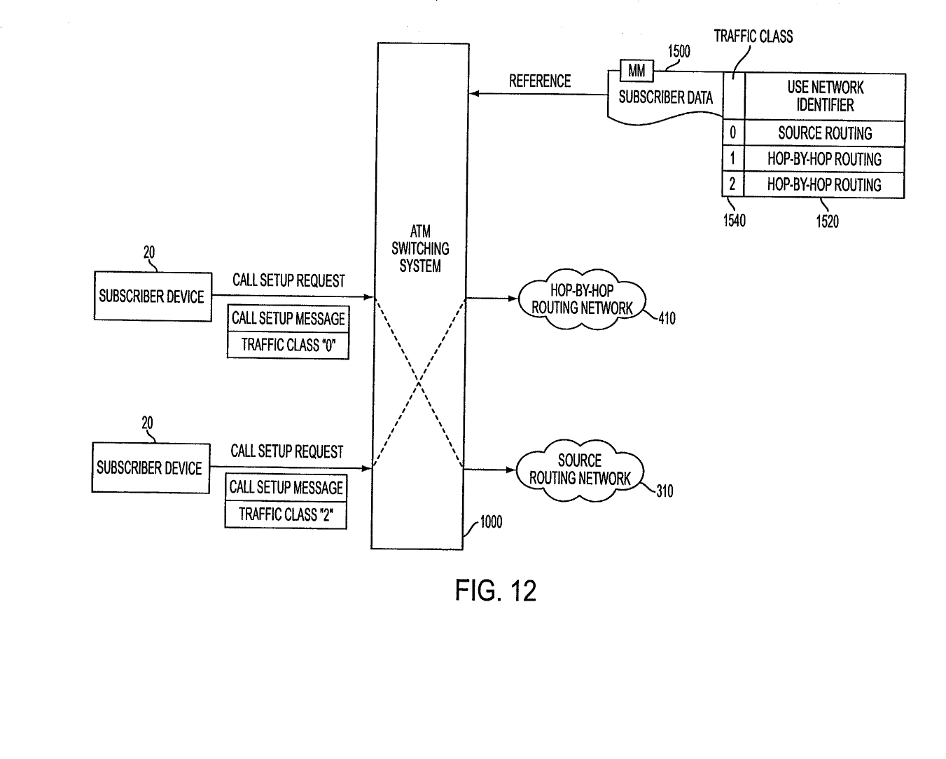

FIG. 12 shows an outline of operations by which a call setup request is routed to desired routing method network based on traffic class information added to the subscriber data. What is different between FIG. 12 and FIG. 1 is that station data 1300 in FIG. 1 is made to correspond in FIG. 12 to traffic class 1540 for each subscriber and use network identifier 1520 and is provided as subscriber data 1500. Traffic class 1540 can be associated with broadband bearer capability 1630 and quality of service parameter 1650 in FIG. 4.

The explanation here will concentrate on the difference that traffic class 1540 is newly provided in the call setup request message from subscriber device 20 and that routing is done based on the value of this traffic class 1540. As traffic class 1540, for example, constant bit rate (CBR) may be handled as “0”, and variable bit rate (VBR) may be handled as “2”. Also, as quality class (QoS class), for example, the values 0-4 may be handled as the value of traffic class 1540.

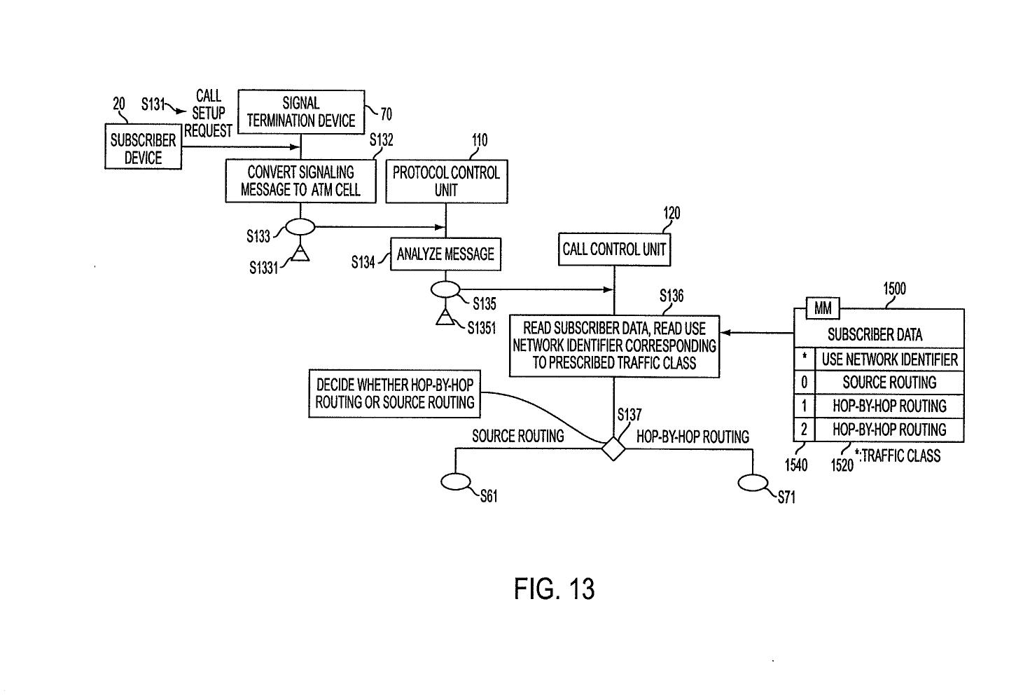

FIG. 13 shows a processing flow (the common portion) by which a call setup request is routed to a desired routing method network based on traffic class information added to the subscriber data. In the following an explanation is given as follows in line with FIG. 13.

In step S131, signal termination device 70 receives a call setup request from subscriber device 20, extracts the setup message as the signaling message included in this call setup request message, activates protocol control unit 110, passes it this setup message, and terminates this processing (steps S131 through S1331).

In step S134, protocol control means 110 analyzes said setup message passed to it when it was activated from signal termination device 70, activates call control unit 120, passes it the call setup information, including path information, subscriber information, quality information, and address, and terminates this processing (steps S134 through S1351).

In step S136, call control unit 120 is passed said call setup information, and reads use network identifier 1520, by which a correspondence is made between the subscriber information included in said call setup information and traffic class 1540 set in subscriber data 1500. Included in read use network identifier 1520 is information indicating either a source routing network or a hop-by-hop routing network. For example, according to subscriber data 1500 in FIG. 13, “hop-by-hop routing” is read as the use network identifier 1520 in which the traffic class corresponds to “2”. With regard to the type of the routing network, it does not matter if it is two or more networks (even if it is the same protocol, cases in which the version numbers are different may be included, and if separation is operationally necessary, it may be completely the same protocol and the same version number).

In step S137, call control means 120 proceeds to step S61 (FIG. 6) if read use network identifier 1520 indicates a source routing network, or to step S71 (FIG. 7) if it indicates a hop-by-hop routing network.

3.5 Fifth Embodiment

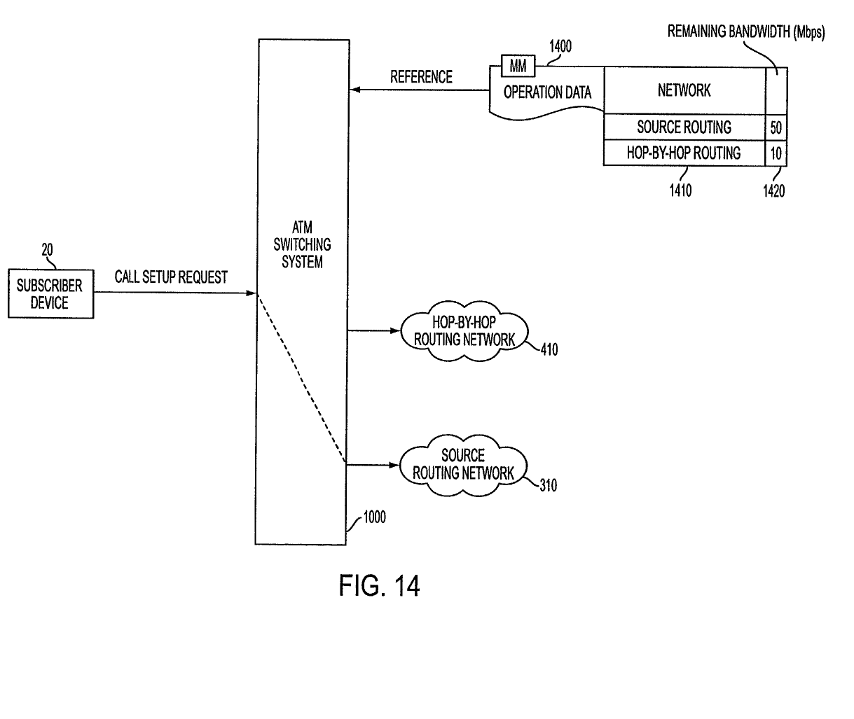

FIG. 14 shows an outline of operations by which a call setup request is routed to a desired routing method network based on remaining bandwidth information. The explanation concentrates on what is different between FIG. 14 and FIG. 1, namely, that station data 1300 in FIG. 4 is made to correspond to remaining bandwidth quantity 1420 and network 1410 in FIG. 12 and is provided as operation data 1400 (FIG. 3).

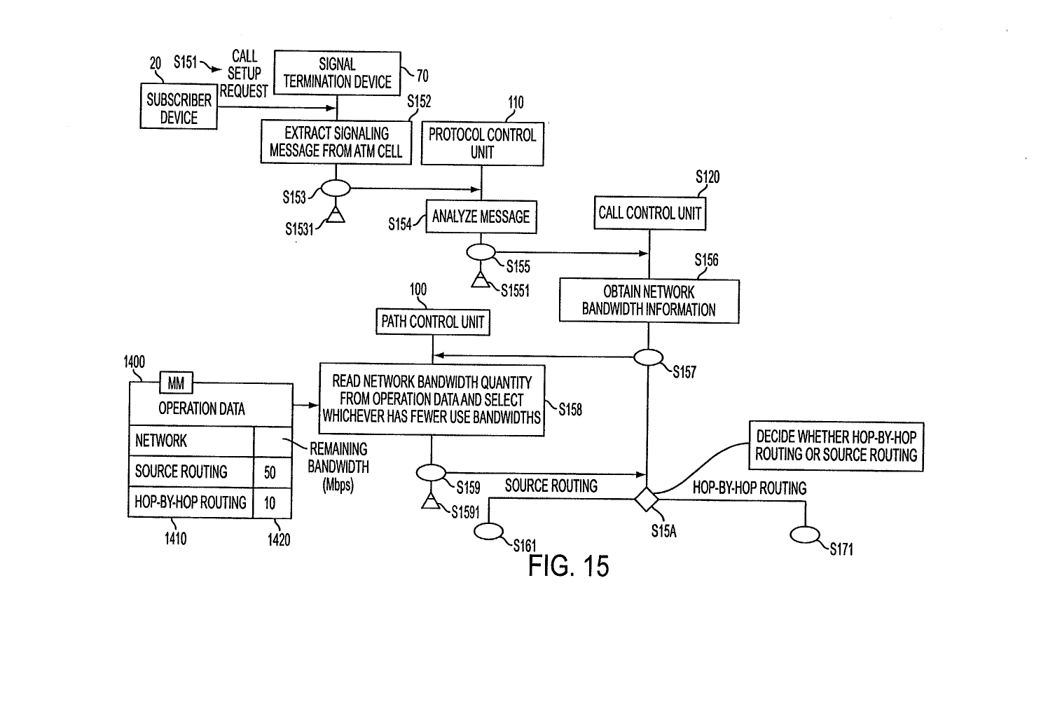

FIG. 15 shows a processing flow (the common portion) by which a call setup request is routed to a desired routing method network based on remaining bandwidth information. In the following an explanation is given as follows in line with FIG. 15.

In step S151, signal termination device 70 receives a call setup request from subscriber device 20, extracts the signaling message (setup message) included in this call setup request, activates protocol control unit 110, passes it this setup message, and terminates this processing (steps S151 through S1531).

In step S154, protocol control unit 110 analyzes said setup message passed to it when it was activated from signal termination device 70, activates call control unit 120, passes it the call setup information, including path information, subscriber information, quality information, and address, and terminates this processing (steps S154 through S1551).

In step S156, call control unit 120 is passed said call setup information, and reads remaining bandwidth 1420 set in operation data 1400. For example, if one selects network 1410, which has a large remaining bandwidth, assuming that remaining bandwidth 1420 indicated on the left side in FIG. 15 is the current remaining bandwidth information (it can be either the network, the physical line, or the logical channel), the remaining bandwidth for the source routing network is 50 Mbps, and for the hop-by-hop routing network it is 10 Mbps. Therefore the remaining bandwidth of the source routing network is 40 Mbps more than the hop-by-hop routing network. In such a case, one can make the selection with priority given to the network having the greater remaining bandwidth (in this example, the source routing network) and can adjust the network load balance. Then it returns to call control unit 120, passes it the information of the selected network 1410, and terminates this processing. Needless to say, it is easy for one skilled in the art to manage the remaining bandwidth for each network unit, physical line, or logical line (steps S156 through S1591).

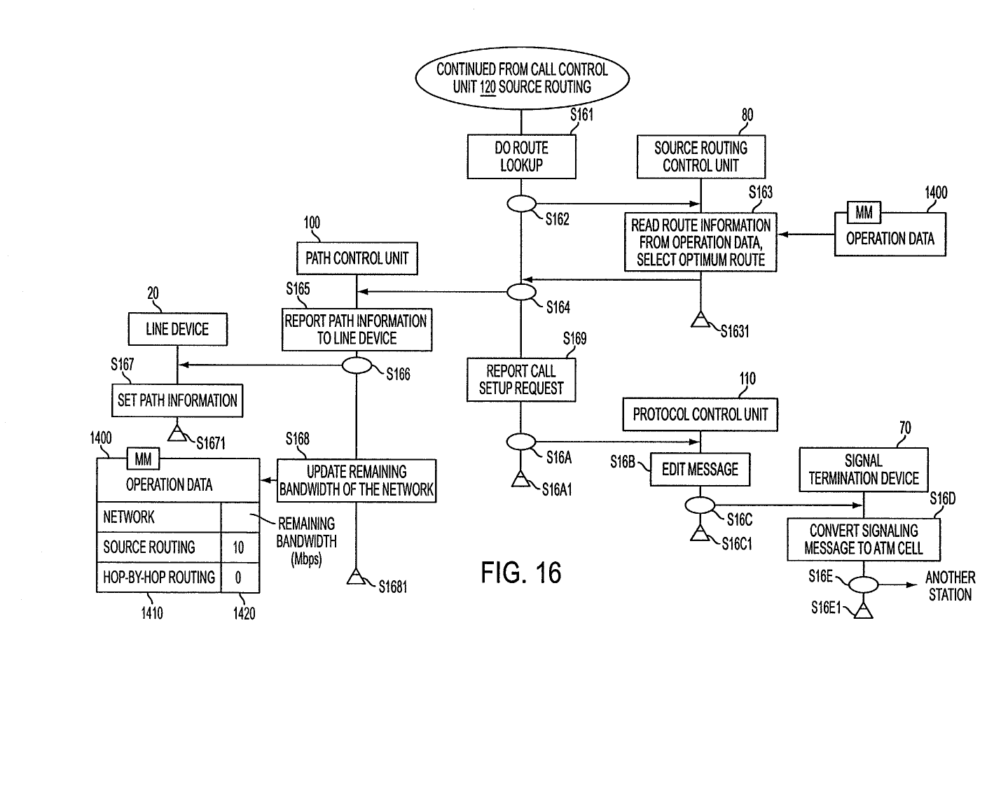

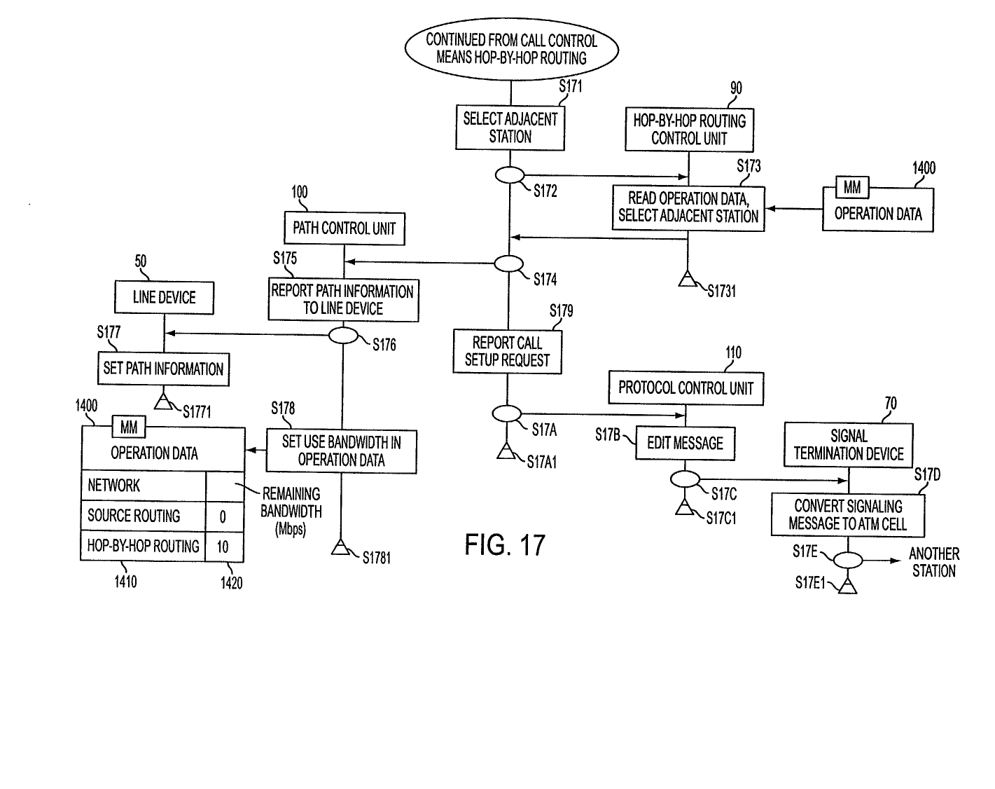

In step S15A, if read use network identifier 1520 indicates a source routing network, one proceeds to step S161 (FIG. 16), and if it indicates a hop-by-hop routing network, one proceeds to step S171 (FIG. 17) (step S15A).

FIG. 16 shows a processing flow (the source routing portion) by which a call setup request is routed to a desired routing method network based on remaining bandwidth information.

In step S161, call control means 120 activates source routing control means 80 to ask source routing control unit 80 for a route lookup request for source routing (steps S161 through S162).

In step S163, it reads the route information from operation data 1400 and selects the optimum route as source routing. Also, stored in route information 1413 of operation data 1400 is the path identification number that reaches said called station corresponding to the called-station number. The station number to be routed through when said received call setup request is transferred is stored in association with this path identification number. In this way, the optimum route necessary for source routing is set. Then one proceeds to step S164 (steps S163 through S1631).

In step S164, one activates path control means 100 and passes to path control means 100 the source routing information (path information) obtained in step S163.

In step S165, path control unit 100 notifies circuit device 50 of the path information passed to it, and line device 50 sets in line device 50 the path information it has been notified of Then it terminates this processing (steps S165 through S1671).

In step S166, it activates line device 50 and sets in operation data 1400 the remaining bandwidth quantity after reserving a bandwidth based on the bandwidth information included in the path information it has been notified of. Here, because source routing processing is done, if the remaining bandwidth of the source routing network is 10 Mbps, the remaining bandwidth corresponding to the source routing of remaining bandwidth 1420 in FIG. 16 is set to 10 Mbps, and this processing is terminated (steps S166 through S1681).

It is clear that the remaining bandwidth is updated when the set path is released, and the specific method of implementation will be easy for one skilled in the art, so it is not explained here.

In aforesaid step S164, one activates path control means 100, activates protocol control means 110 in order to inform protocol control unit 110 of the call setup request information, and terminates this processing (steps 164 through S16A1).

In step S16B, protocol control unit 110 edits the signaling message included in the call setup request, passes the call setup request information to, and activates, the signal termination device 70, and terminates this processing (steps S16B through S16C1).

In step S16D, signal termination device 70 converts the received signaling message to an ATM cell and sends it to another station switching system 30 of a source routing network. Then it terminates this processing.

FIG. 17 shows a diagram explaining a processing flow (the hop-by-hop routing portion) by which a call setup request is routed to a desired routing method network bandwidth on remaining bandwidth information.

In the diagram, in step S171, in order to select that hop that will handle the next hop-by-hop routing, one activates hop-by-hop routing control unit 90 and waits for the processing results from activated hop-by-hop routing control unit 90 (steps S171 through S172).

In step S173, one selects the next hop (adjacent station) by referring to hop-by-hop routing information 1420 of operation data 1400. Then it passes the selected adjacent station information to the activation source (call control unit 120) and returns (steps S173 through S1731).

In step S174, one activates path control unit 100 and passes on said adjacent station information (path information). At path control means 100, one activates line device 50 and informs line device 50 of the path information based on said adjacent station information (steps S174 through S1771).

In step S178, the remaining bandwidth quantity after the bandwidth for said path is reserved is set in operation data 1400 bandwidth on the bandwidth information included in the path information that circuit device 50 is notified of. Here, hop-by-hop routing processing is done, or for example, if the remaining bandwidth of the hop-by-hop routing network is 10 Mbps, the remaining bandwidth corresponding to hop-by-hop routing of remaining bandwidth 1420 in FIG. 17 is set to 10, and this processing is terminated. Also, it is clear that the remaining bandwidth will be updated when said set path is released, and the specific method of implementation will be easy for one skilled in the art, so an explanation is omitted here (steps S176 through S1781).

In step S179, one activates protocol control unit 110 and notifies protocol control unit 110 of said call setup request. Then one terminates this processing (steps S179 through S17A1).

In steps 17B, protocol control unit 110 edits the signaling message included in the call setup request, activates signal termination device 70, and informs signal termination device 70 of the message. Then it terminates this processing (steps S7B through S7C1).

In step S17D, signal termination device 70 converts the received signaling message to an ATM cell and sends it via switch 60 to an other station, for example, other switching system 40 connected to hop-by-hop routing network 410 (steps S17D through S17E1).

3.6 Sixth Embodiment

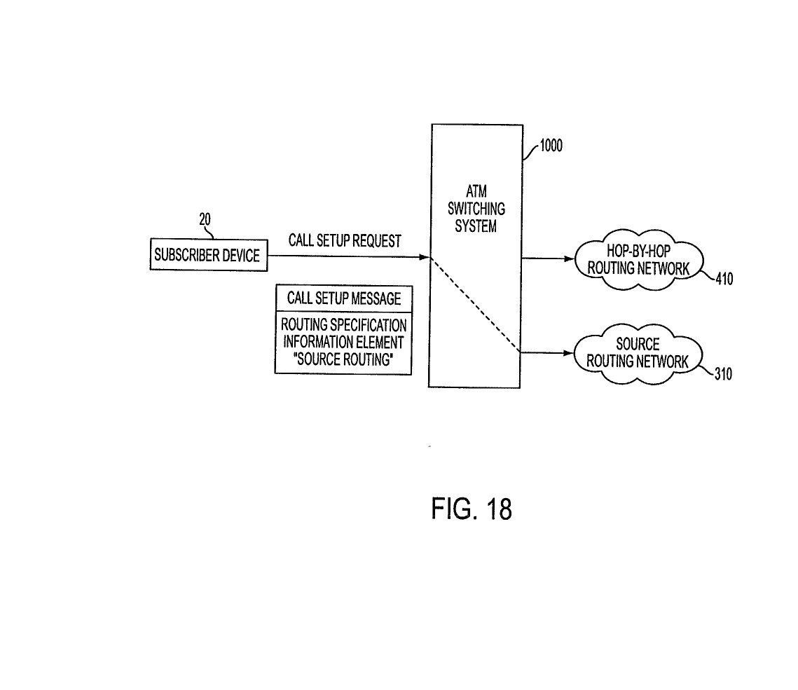

FIG. 18 is a diagram for explaining an outline of operations by which a call setup request is routed to a desired routing method network based on information elements included in the call setup request.

The explanation concerns the difference between FIG. 18 and FIG. 1, namely, that a routing destination is selected based on information specified by the information elements included in the call setup request in FIG. 18. For example, as an information element, if “1” is set in use routing 1604 as shown in FIG. 4, it is hop-by-hop routing, and if “2” is set, it is source routing.

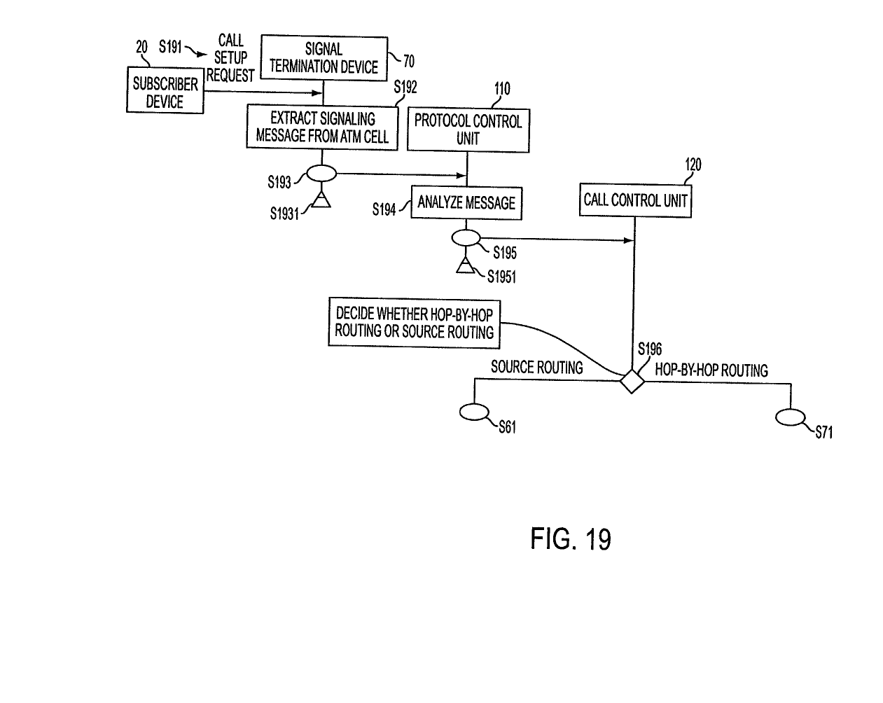

FIG. 19 is a diagram for explaining a processing flow (the common portion) by which a call setup request is routed to a desired routing method network based on information elements included in the call setup request.

In step S191, signal termination device 70 receives a call setup request from subscriber device 20, extracts the setup message, which is the signaling message included in this call setup request message, activates protocol control means 110, passes it this setup message, and terminates this processing (steps S191 through S1931).

In step S194, protocol control unit 110 analyzes said setup message passed to it when it was activated from signal termination device 70, activates call control means 120, passes it the call setup information, including path information, subscriber information, quality information, and address, and terminates this processing (steps S194 through S1951).

In step S120, call control unit 120 is passed said call setup information, and decides whether it is a source routing network or a hop-by-hop network based on a value of use routing 1604 included in the information elements included in said call setup information.

In step S196, if a value of extracted use routing 1604 indicates a source routing network, one proceeds to step S61 (FIG. 6), and if it indicates a hop-by-hop routing network, one proceeds to step S71 (FIG. 7).

3.7 Seventh Embodiment

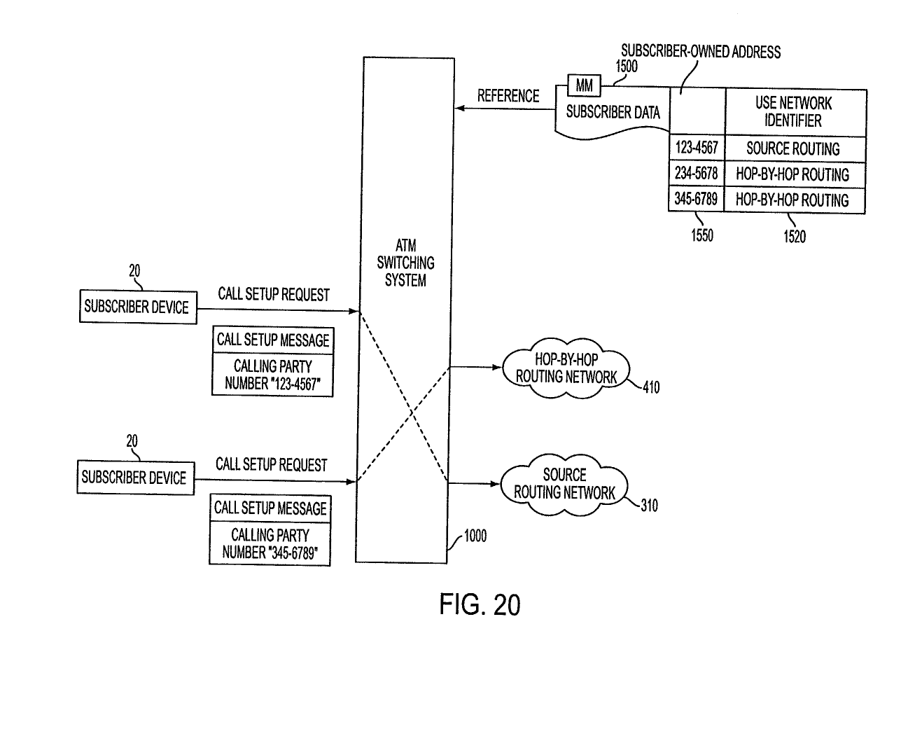

FIG. 20 is a diagram for explaining an outline of the operations by which a call setup request is routed to the desired routing method network based on an information element (calling party number) included in the call setup request.

What is different between FIG. 20 and FIG. 1 is that the routing destination is selected based on the calling party number specified by an information element included in the call setup request in FIG. 20. The explanation concentrates on this difference. This calling party number can be set in, for example, use routing 1604 (FIG. 4), as shown in FIG. 2. In this case, if it contains a value other than “1” or “2”, it can be treated as a situation in which said calling party number is set. Also, called party number information 1640 can be used instead of use routing 1604.

ATM switching system 1000, upon receiving a call setup request, extracts said calling party number, searches for a match between this calling party number and a subscriber-owned address in subscriber data 1500, and if a match is found, extracts the corresponding use network identifier 1520. Then, based on the value of this use network identifier 1520, it decides upon either hop-by-hop routing or source routing and routes the received call setup request to the desired network.

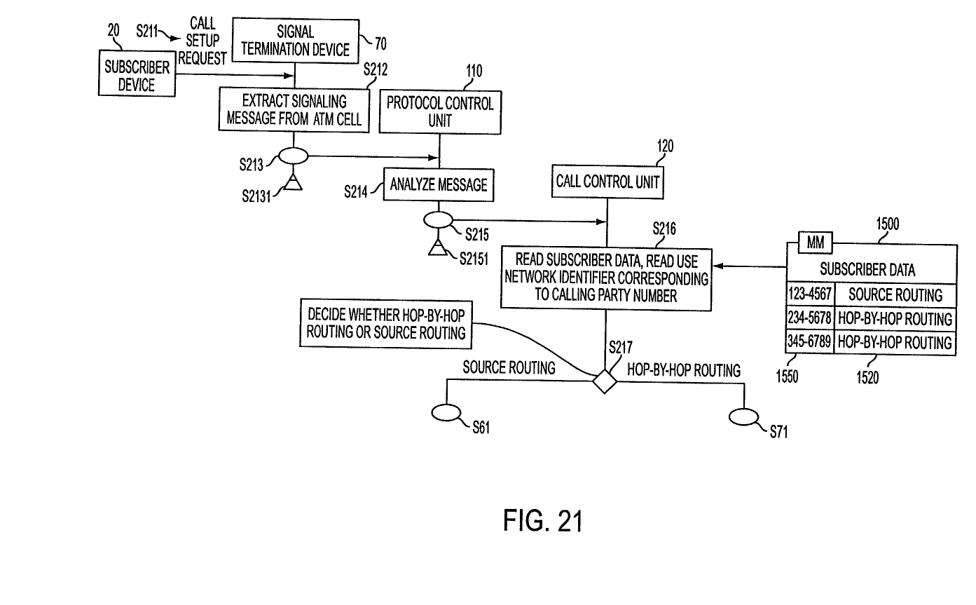

FIG. 21 is a diagram for explaining the processing flow (the common portion) by which a call setup request is routed to the desired routing method network based on information elements (calling party number) included in the call setup request.

In step S211, signal termination device 70 receives a call setup request from subscriber device 20, extracts the setup message, which is the signaling message included in this call setup request, activates protocol control unit 110, passes it this setup message, and terminates this processing (steps S211 through S2131).

In step S214, protocol control unit 110 analyzes said setup message passed to it when it was activated from signal termination device 70, activates call control unit 120, passes it the call setup information, including path information, subscriber information, quality information, and address, and terminates this processing (steps S214 through S2151).

In step S216, call control unit 120 is passed said call setup information, and extracts the value of calling party number 1640 (FIG. 4) included in the information elements of said call setup information. Then it searches for data giving a match between the extracted calling party number and a subscriber-owned address 1550 in subscriber data 1500. If matching data is found, it extracts the use network identifier 1520 that corresponds to this subscriber-owned address. Stored in this use network identifier is information that indicates either hop-by-hop routing or source routing. For example, it may be defined so that if the value of this information is “1”, it is a source routing network, and if it is “2”, it is a hop-by-hop routing network.

In step S217, if the value of extracted use network identifier 1520 indicates a source routing network, one proceeds to step S61 (FIG. 6), and if it indicates a hop-by-hop routing network, one proceeds to step S71 (FIG. 7).

3.8 Eighth Embodiment

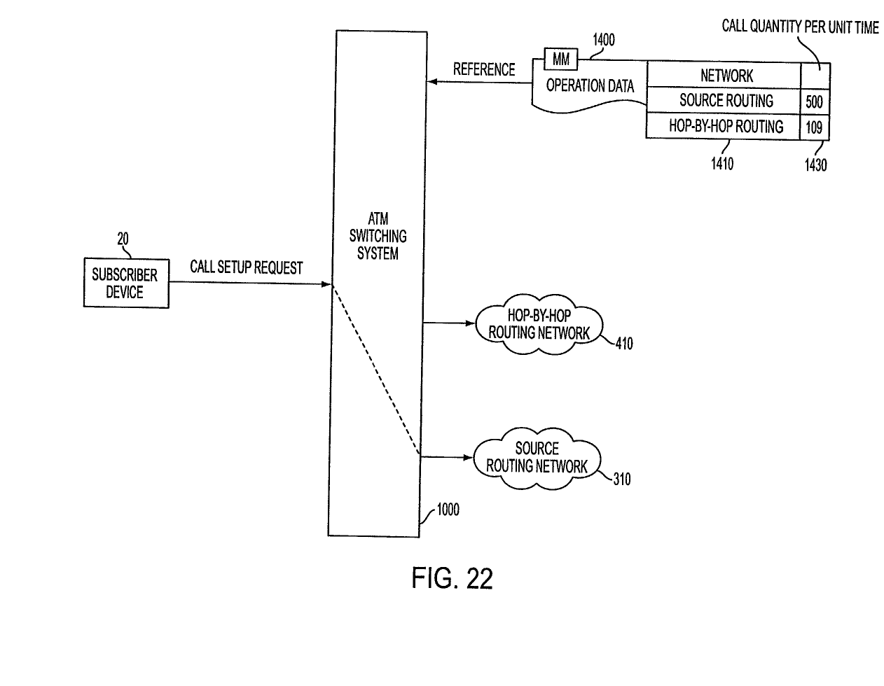

FIG. 22 is a diagram for explaining an outline of the operations by which routing is done to the desired routing method network according to the call quantity per unit time at the calling station.

What is different between FIG. 22 and FIG. 1 is that when a call setup request is received in FIG. 22, the network of the routing destination is selected based on the call quantity per unit time monitored by ATM switching system 1000. The explanation concentrates on this difference. Said call quantity is set in, for example, the call quantity of common 1430. In this case, the call quantity per unit time of the network is set in correspondence to the routing network (FIG. 3).

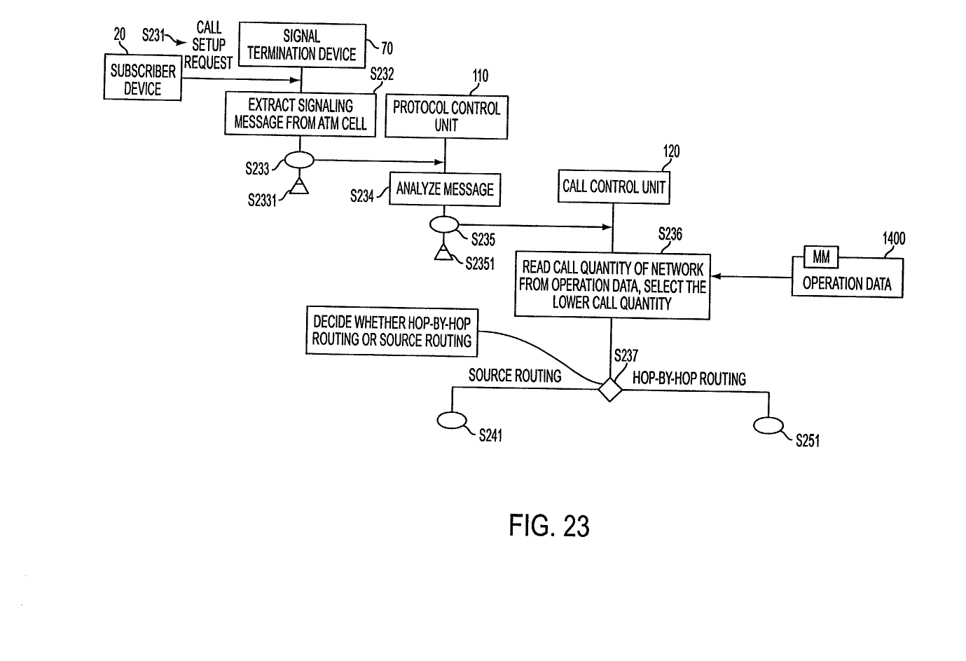

FIG. 23 is a diagram for explaining the processing flow (the common portion) by which routing is done to the desired routing method network according to the call quantity per unit time at the calling station. In the following an explanation is given as follows in line with FIG. 23.

In step S231, signal termination device 70 receives a call setup request from subscriber device 20, extracts the setup message, which is the signaling message included in this call setup request, activates protocol control unit 110, passes it this setup message, and terminates this processing (steps S231 through S2331).

In step S234, protocol control unit 110 analyzes said setup message, which is the signaling message passed to it when it was activated from signal termination device 70, activates call control unit 120, passes it the call setup information, including path information, subscriber information, quality information, and calling party, and terminates this processing (steps S234 through S2351).

In step S236, call control unit 120 is passed said call setup information, and reads from operation data 1400 the current call quantity 1418 per unit time. Set in the read call quantity 1418 is said call quantity in a source routing network or hop-by-hop routing network. Thus it preferentially selects whichever has the smaller call quantity per unit time in the source routing network or hop-by-hop routing network. Because of this, it is possible to appropriately balance the network load.

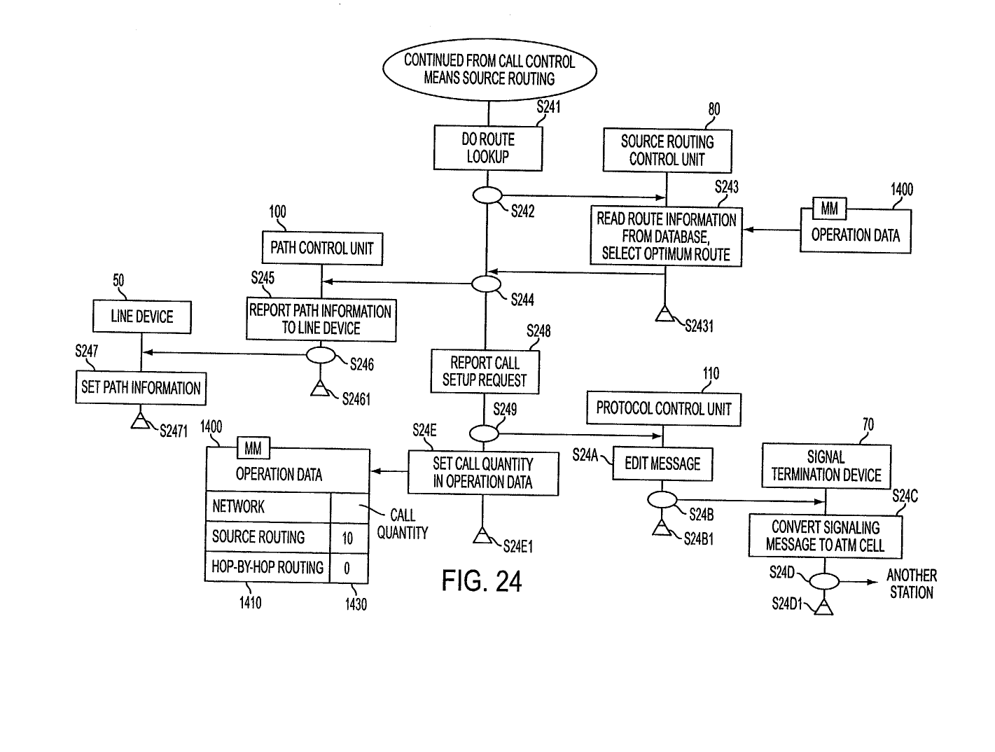

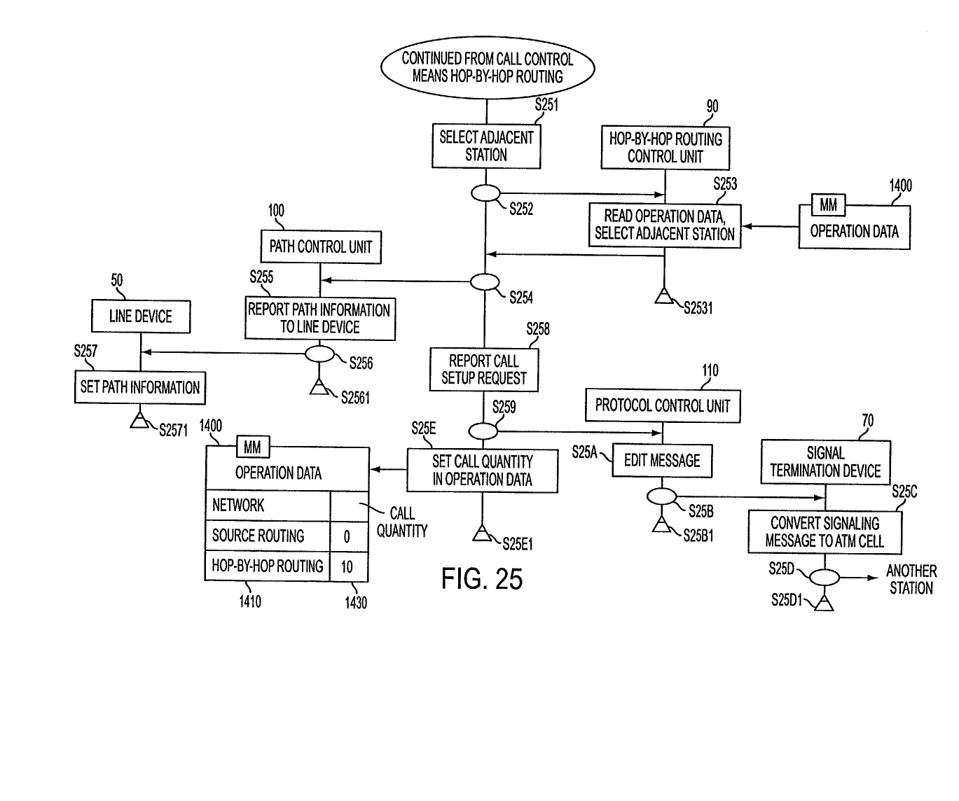

In step S237, if the lower of read call quantity 1418 indicates a source routing network, one proceeds to step S241 (FIG. 24), and if it indicates a hop-by-hop routing network, one proceeds to step S251 (FIG. 25).

FIG. 24 shows the processing flow (source routing) by which routing is done to the desired routing method network according to the call quantity per unit time at the calling station.

In step S241, call control unit 120 activates source routing control means 80 in order to make a route lookup request to source routing control means 80 (steps S241 through S242).

In step S243, source routing control unit 80 reads route information 1413 from operation data 1400 and selects the optimum route as source routing. Stored in route information 1413 of operation data 1400 is the path identification number that reaches said called station corresponding to the called-station number. The station number to be routed through when the received call setup request is transferred is stored in association with this path identification number. Based on such information, the optimum route necessary for source routing is selected. Then one proceeds to step S244 (steps S243 through S2431).

In step S244, call control unit 120 activates path control means 100 and passes to path control means 100 the source routing information (path information) obtained in step S243.

In step S245, path control unit 100 notifies circuit device 50 of the path information passed to it, and circuit device 50 sets in circuit device 50 the path information it has been notified of (steps S245 through S2471).

In step S248, one activates protocol control unit 110 in order to notify protocol control means 110 of the call setup request, adds 1 to call quantity 1430 corresponding to source routing, and terminates this processing. Also, when a release request (REL message) from subscriber device 20 is received, one judges the type of the connection network and subtracts 1 from call quantity 1430 of the relevant routing network. This processing, although unrelated with this step, may be executed at the release processing location. The intent of such call quantities is to use the quantities completed by the call setting at the present time as an index of the load on each network.

Also, for the call quantity one can adopt the cumulative value of the call setup request. That is, it is not based on the temporary load, and the intent is to use it as an index of the average load of the networks. (steps S248 through S24E1)

In step S24A, protocol control unit 110 edits the signaling message included in the received call setup request, passes on this message, activates signal termination device 70, and terminates this processing (steps S24A through S24B1).

In step S24C, signal termination device 70 converts the received signaling message to an ATM cell and sends it to other station switching system 310 of a source routing network. Then it terminates this processing (steps S24C through S24D1).

FIG. 25 is a diagram for explaining the processing flow (hop-by-hop routing) by which routing is done to the desired routing method network according to the call quantity per unit time at the calling station.

In the diagram, in step S251, in order to select the hop for the next hop-by-hop routing, call control means 120 activates hop-by-hop routing control unit 90 and waits for the processing results from activated hop-by-hop routing control unit 90 (steps S251 through S252).

In step S253, hop-by-hop routing control unit 90 refers to hop-by-hop routing information 1420 of operating data 1400 and selects the next hop (adjacent station). Then it passes the selected adjacent station information to the activation origin (call control unit 120) and returns (steps S253 through S2531).

In step S254, call control unit 120 activates path control unit 100 and passes it said adjacent station information (path information). At path control unit 100, line device 50 is activated, and based on the adjacent station information, line device 50 is notified of said path information, and this processing is terminated (steps S254 through S2561).

In step S256, path control unit 100 activates line device 50 and passes the path information to it, and activated circuit device 50 sets in said line device 50 the path information that has been passed to it, and terminates this processing (steps S256 through S2571).

In step S258, one activates protocol control unit 110 in order to notify protocol control means 110 of the call setup request, adds 1 to call quantity 1430 corresponding to source routing, and terminates this processing (steps S258 through S25E1).

Also, when a release request (REL message) from subscriber device 20 is received, one judges the type of the connection network and subtracts 1 from call quantity 1430 of the relevant routing network. This processing, although unrelated with this step, may be executed at the release processing location. This will be obvious to one skilled in the art. Also, if one adopts the cumulative value of the call setup request as a call quantity index, such subtraction processing of call quantity 1430 is unnecessary.

In step S25A, protocol control unit 110 edits the signaling message included in said call setup request, activates signal termination device 70, and notifies signal termination device 70 of this message. Then it terminates this processing (steps S25A through S25B1).

In step S25C, signal termination device 70 converts the received signaling message to an ATM cell and sends it to an other station, for example, other station switching system 40 connected to hop-by-hop routing network 410. Then it terminates this processing (steps S25C through S25D1).

3.9 Ninth Embodiment

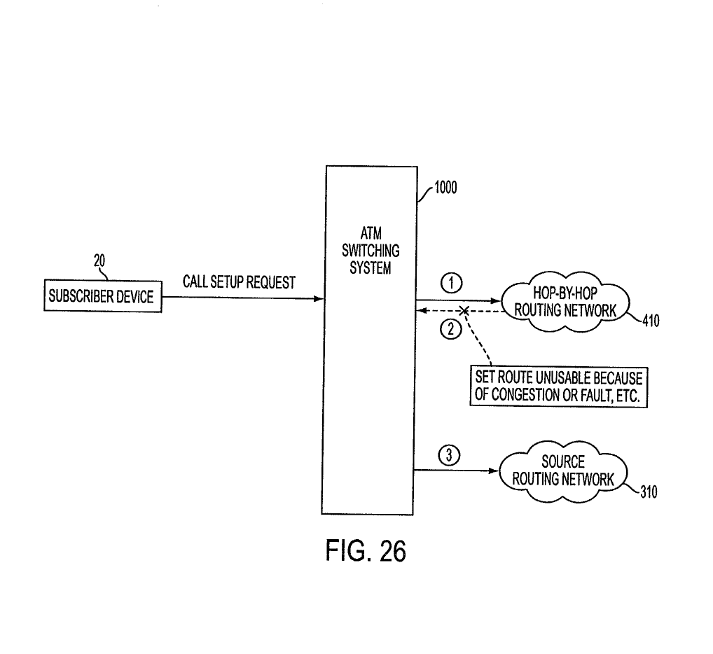

FIG. 26 is a diagram for explaining an outline of the operations by which a call setup request from a subscriber is detour-controlled when congestion or a fault occurs. The explanation is given in line with FIG. 26.

Upon receiving a call setup request from subscriber device 20, assuming for example that said call setup request has been sent to a hop-by-hop routing network, if ATM switching system 1000 receives a “release request message (REL: release message)” to the effect that this network cannot be used due to congestion or a fault, etc., then ATM switching system 1000 can route said received call setup request to another network, bypassing the unusable condition caused by the fault or congestion of the network.

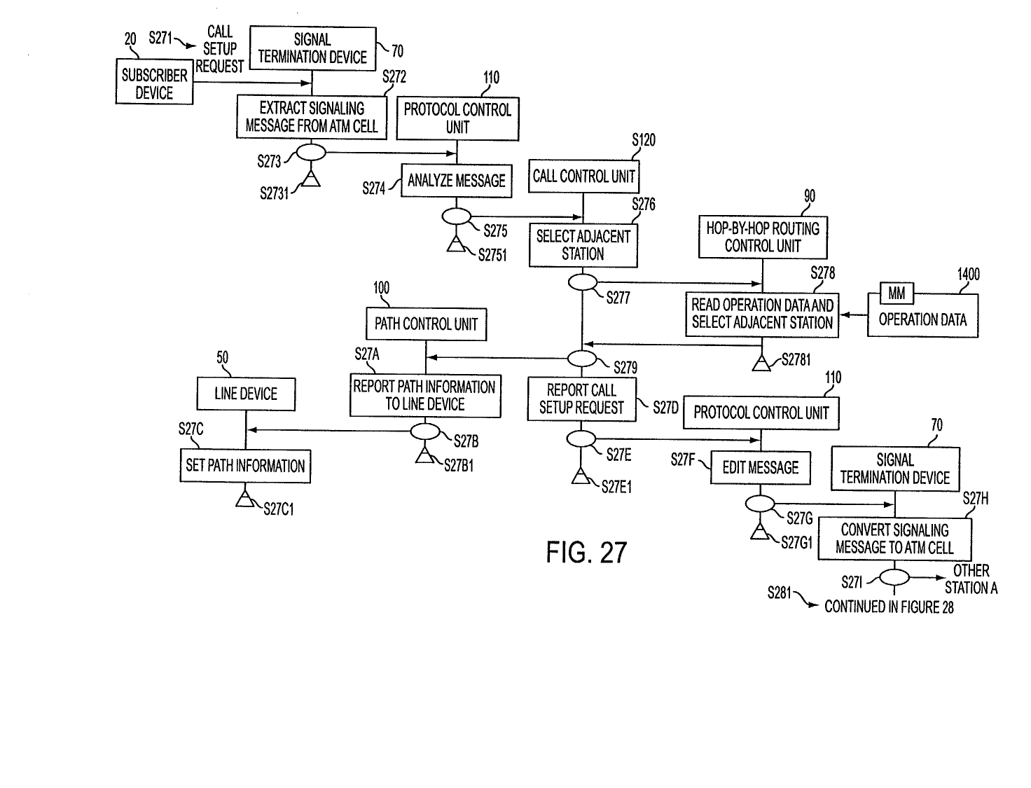

FIG. 27 is a diagram for explaining a processing flow (part 1) by which a call setup request from a subscriber is detour-controlled when congestion or a fault occurs. The explanation is given as follows in line with FIG. 27.

In step 271, signal termination device 70 receives a call setup request from subscriber device 20, extracts the setup message as a signaling message included in this call setup request, activates protocol control unit 110, passes it this setup message, and terminates the processing (steps S271 through S2731).

In step S274, protocol control unit 110 analyzes said setup message passed to it when it was activated from signal termination device 70, activates call control unit 120, passes it the call setup information, including path information, subscriber information, quality information, and address, and terminates this processing (steps S274 through S2751).

In step S276, call control unit 120 holds said call setup information so that a call can be made again even if a call based on said passed call setup information is refused. In order to select the next hop for hop-by-hop routing, it passes on said call setup information, activates hop-by-hop routing control unit 90, and waits for the processing results from activated hop-by-hop routing control unit 90 (steps S276 through S277).

In step S278, it selects the next hop (adjacent station) by referring to hop-by-hop routing information 1420 of operation data 1400 in station data 1300. Then it passes the selection result to the activation origin (call control unit 120), returns, and terminates the processing of hop-by-hop routing control unit 90 (steps S278 through S2781).

In step S279, call control unit 120 activates path control means 100 and passes said adjacent station information to it. At path control means 100, it activates line device 50, notifies line device 50 of the path information based on the adjacent station information (path information), and terminates this processing (steps S279 through S27B1).

In step S27C, the circuit device 50 performs path setting based on the path information that has been passed to it. Then it terminates this processing (steps S27C through S27C1).

In step S27D, the call control unit 120 reports to protocol control unit 110 said call setup request and adjacent station information as a signaling message, and activates protocol control unit 110. Then it terminates this processing (steps S27D through S27E1).

In step S27F, it edits said reported signaling message, activates signal termination device 70, and reports the signaling message to signal termination device 70. Then it terminates this processing (steps S27F through S27G1).

In step S27H, it converts the received signaling message to an ATM cell and sends it via switch 60 to an other station, for example, to another station switching system 40 connected to hop-by-hop routing network 410. Then it proceeds to step S281 (steps S27H through S27I).

In step S281, signal termination device 70, upon receiving a call release request from an other station switching system, etc., extracts the message included in said call release request. That is, by step S27H, it means that the signaling message sent to an other station switching system has been refused. Thereupon, signal termination device 70 activates protocol control unit 110, passes said message to it, and terminates this processing (steps S281 through S2831).

In step S284, protocol control unit 110 analyzes said signaling message passed to it from signal termination device 70, activates call control unit 120, passes it the call setup information including path information, subscriber information, quality information, and address, and terminates this processing (steps S284 through S2851).

In step S286, call control unit 120 passes on said message, activates path control means 100, and proceeds to step S28A.

In step S287, path control unit 100 activates line device 50 and passes said message to it, and based on said message, activated line device 50 releases the previously set up path. Then it terminates the processing of circuit device 50 (steps S287 through S2891).

In step S28A, upon recognizing that the signaling message sent by step S27H has been refused, call control unit 120 selects by aforesaid step S281 and concludes that the route cannot be used, so it retrieves a different route. The processing of aforesaid step S277 activates source routing control unit 80, extracts source routing information, and passes the source routing information to the call origin. Then it terminates this processing (steps S28A through S28C1).

In step S28D, call control means 120 activates aforesaid path control unit 100 and passes it said source routing information (path information). Then it proceeds to step S28H.

In step S28E, call control unit 120 activates path control unit 100 and passes it said path information. Path control means 100 activates circuit device 50, reports said path information to circuit device 50, and terminates the processing (steps S28E through S28F1).

In step S28G, circuit device 50 is activated, and this line device 50 sets up the path based on the path information passed to it. Then it terminates this processing (steps S28G through S28G1).

In step S28H, call control unit 120, because it holds said call setup information for the case in which said signaling message is refused, generates call setup request information from the call setup information and said adjacent station information. Then it activates path control means 100, passes it the call setup request information (signaling message), and terminates the processing of call control unit 120.

In aforesaid step S28I, call control unit 120 passes on the call setup request information and activates protocol unit 110. Then it terminates this processing (steps S28I through S2811).

In step S28J, protocol control unit 110 edits the signaling message included in the call setup request information, activates signal termination device 70, and reports the signaling message to signal termination device 70. Then it terminates this processing (steps S28J through S28K1).

In step S28L, the received signaling message is converted to an ATM cell and is sent via switch 60 to another station, for example, to other station switching system 30 connected to source routing network 31. Then it terminates this processing (steps S28L through S28M1).

In this embodiment, in the routing results of the call setup request by hop-by-hop routing, when this call setup request is refused, routing is done by source routing as a substitute route, and detour processing is realized.

However, from the previously disclosed content, it is clear that one skilled in the art can easily realize initially doing call setup request processing by source routing, and when it is refused, doing detour processing of said call setup request by hop-by-hop routing processing.

3.10 Tenth Embodiment

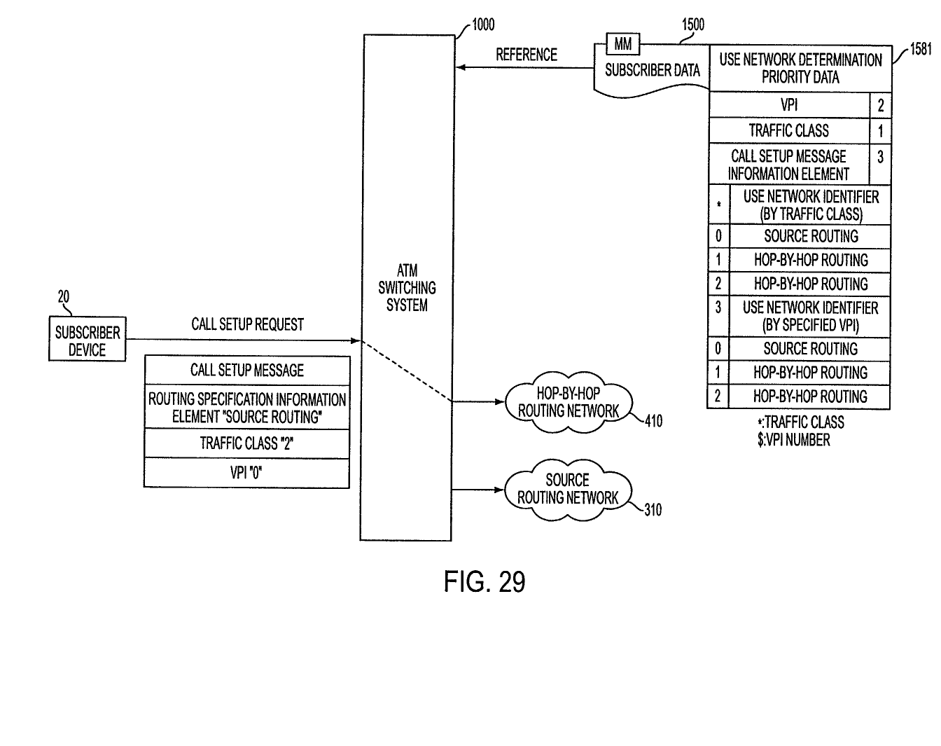

FIG. 29 shows an outline of operations by which a call setup request is routed to a desired routing method network based on information elements added to the call setup request and the priority set in the subscriber information. The explanation is given in line with FIG. 29.

ATM switching system 1000 simultaneously specifies the information elements (for example, subscriber-owned address, etc.) traffic class, and VPI number (VPI No.) of the routing specification in aforesaid call setup request from subscriber device 20, and sends the call setup request to the desired routing network in accordance with the priority indicated by use network determination priority data 1581 that corresponds to these.

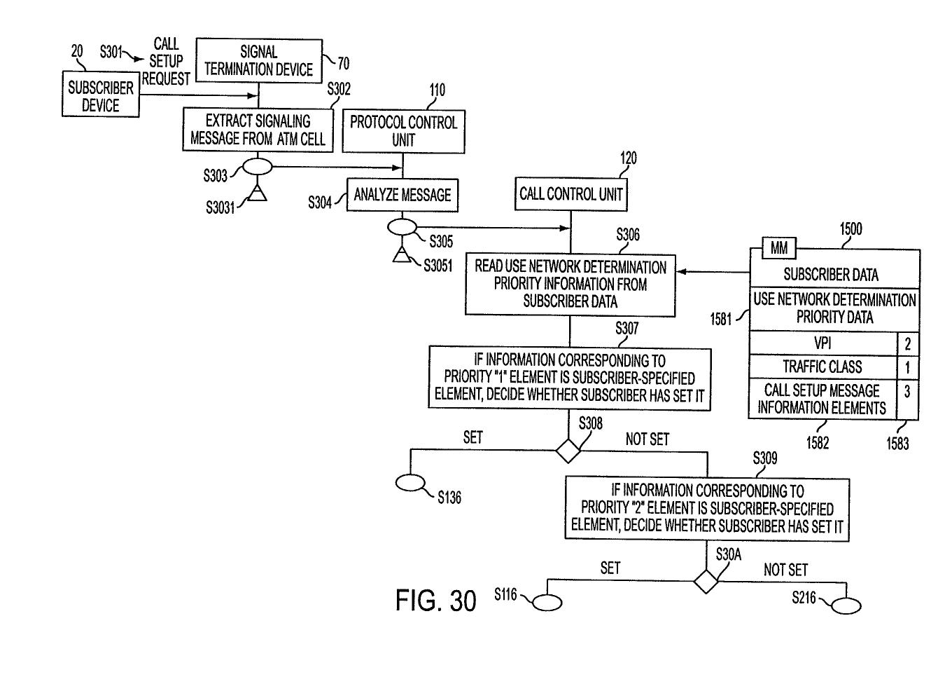

FIG. 30 is a diagram for explaining the processing flow (the common portion) by which a call setup request is routed to the desired routing method network based on information elements added to the call setup request and the priority set in the subscriber information. The explanation is given in line with the diagram.

In step S301, signal termination device 70 receives a call setup request from subscriber device 20, extracts the setup message that is the signaling message included in this call setup request, activates protocol control unit 110, passes it this setup message, and terminates this processing (steps S301 through S3031).

In step S304, protocol control unit 110 analyzes said setup message passed to it when it was activated from signal termination device 70, activates call control unit 120, passes it call setup information including path information, subscriber information, quality information, and called party number, and terminates this processing (steps S304 through S3051).

In step S306, call control unit 120 is passed the call setup information and reads use network determination priority data 1581 set in subscriber data 1500. Priorities are set in read use network determination priority data 1581 for the VPI number, traffic class, and call setup message information elements, respectively. According to use network determination priority data 1581 shown in FIG. 30, the traffic class is set to first priority, the VPI number is set to second priority, and the call setup message information elements are set to third priority.

In step S307, one decides whether the data is set to first priority. For example, according to subscriber data 1500 in FIG. 30, first priority is the traffic class. Therefore it is necessary to decide whether the traffic class is set in the call setup request from the subscriber device as data that falls under the first priority.

In step S308, for first-priority use network determination priority data 1581, one decides whether it is information set by the subscriber, and if so, one performs the processing. In this example, the processing is traffic class, so one proceeds to step S136, but if the processing were the VPI number, one would proceed to step S116, and if it were call setup message information elements, one would proceed to step S216.

In aforesaid step S308, regardless of whether it is information to be set by the subscriber, if the information has not been set, it is decided as step S309 whether the second-priority use network determination priority data 1581 is information to be set by the subscriber, and if so, the processing is done. In this example, the processing is the VPI number, so one proceeds to step S116, but the processing would be to proceed to step S136 if the second priority were the traffic class, and it would be to proceed to step S216 if it were call setup message information elements.

In aforesaid step S309, if the information has not been set even though it is information to be set by the subscriber, then as step S30A one decides whether the third-priority use network determination priority data 1581 is information to be set by the subscriber, and if it is set, one performs the processing. In this example, that processing is to proceed to step S216, because it is call setup message information elements, but the processing is to proceed to step S136 if the third priority is traffic class, and to proceed to step S116 if it is the VPI number. Similarly in the event of use network determination priority data 1581 of fourth priority or beyond, the same can be done as an extension of the aforesaid processing. Advantage of the present invention

As described above, this invention has the following advantages.

(1) A switching system that receives a call setup request from a subscriber devices can accommodate multiple networks and route the call setup request to a desired network based on information set in the call setup request from the subscriber device. This makes it possible, for example, for the subscriber device to be connected to the desired network among the multiple networks.

(2) A switching system that receives a call setup request from a subscriber device can accommodate multiple networks and provide a means to connect the call setup request from the subscriber device based on the state of each network so as to disperse the network load.

(3) A switching system that receives a call setup request from a subscriber device can accommodate multiple networks, and can provide means whereby, if the call setup request from the subscriber device cannot be connected via the desired network, it can be connected to the called node via a detour route.

(4) In a switching system that receives a call setup request from a subscriber device, the call setup request received from the subscriber device has multiple items of information on which the routing is based, and by routing the call setup request to a desired network in accordance with priorities corresponding to the multiple items of information, this switching system can be operated flexibly merely by changing the settings of the priority data corresponding to the information included in the call setup request.

What is claimed is:

1. A switching system for accommodating a plurality of subscriber devices, and multiple networks, and transmitting a call setup request received from a subscriber device of the plurality of subscriber devices to a network among the multiple networks, the switching system comprising:
a switch receiving a call setup request having an information element from the subscriber device;
a call control unit collating the information element and station data, and extracting, from the station data, a network identification information that corresponds to the information element; and
a routing control unit selecting, based on the network identification information, a network from the multiple networks which include at least two different routing methods.

2. The switching system according to claim 1, wherein the multiple networks include at least a B-ISUP network and a PNNI network.

3. The switching system according to claim 1, wherein the information element is a subscriber identifier.

4. The switching system according to claim 1, wherein the information element includes a value of the network identifier indicating a routing destination.

5. The switching system according to claim 1, wherein the information element includes a value of a traffic class.

6. The switching system according to claim 1, wherein the information element includes a value of a network identifier indicating a routing destination.

7. A switching system for accommodating a plurality of subscriber devices, and multiple networks, and transmitting a call setup request received from a subscriber device of the plurality of subscriber devices to a network among the multiple networks, the switching system comprising:
a switch receiving a call setup request having an information element from the subscriber device;
a call control unit collating station data and the information element, and extracting network identification information that corresponds to the information element; and
a routing control unit selecting, based on a state of use of each of the multiple networks, a network among the multiple networks which include at least two different routing methods.

8. The switching system according to claim 7, wherein the routing control unit selects a network in which a remaining bandwidth of the multiple networks is greater.

9. The switching system according to claim 7, wherein the routing control unit selects a network in which a call quantity per unit time of the multiple networks is small.

10. The switching system according to claim 7, wherein when the transmitted call setup request is refused, the switch transmits the call setup request to another network other than the network.

11. The switching system according to claim 7, wherein the call setup request received from the subscriber device includes information elements on which the routing is based, and station data that includes priorities corresponding to each of the information elements and network identifiers corresponding to each value of the information elements, and wherein
the routing control unit selects a network among the networks based on a network identifier corresponding to the top priority.

12. A routing method for a switching system that accommodates a subscriber device and multiple networks, comprising the steps of:
receiving a call setup request having an information element from said subscriber device;
selecting a network identifier from network identifiers stored in station data, based on a value of the information element;
selecting a network among multiple networks based on a value of the network identifier; and
transmitting the call setup request to the network.

13. The routing method according to claim 12, wherein the multiple networks include at least a PNNI network and a B-ISUP network.
